(19) United States
(12) Patent Application Publication
(10) Pub. No.: US 2025/0317096 A1
(43) Pub. Date: Oct. 9, 2025

(54) Corrugated Solar Panels for Improved Installation and Water-Tight Mounting

(71) Applicant: SOLARPAINT LTD., YOKNEAM ILLIT (IL)

(72) Inventors: Ramon Joseph Albalak, Haifa (IL); Haggai Manor, Beit Lehem HaGlilit (IL)

(21) Appl. No.: 19/241,625

(22) Filed: Jun. 18, 2025

Related U.S. Application Data
(63) Continuation of application No. PCT/IL2023/051290, filed on Dec. 20, 2023.
Application No. PCT/IL2023/051290 is a continuation-in-part of application No. 18/129,865, filed on Apr. 2, 2023.
Application No. 18/129,865 is a continuation of application No. PCT/IL2021/051202, filed on Oct. 7, 2021.
Application No. PCT/IL2021/051202 is a continuation-in-part of application No. 17/353,867, filed on Jun. 22, 2021, now Pat. No. 11,978,815.
Application No. 18/129,865 is a continuation-in-part of application No. 17/353,867, filed on Jun. 22, 2021, now Pat. No. 11,978,815.
Application No. 17/353,867 is a continuation-in-part of application No. 16/362,665, filed on Mar. 24, 2019, now Pat. No. 11,081,606.
Application No. 17/353,867 is a continuation-in-part of application No. PCT/IL2019/051416, filed on Dec. 26, 2019.
Application No. PCT/IL2019/051416 is a continuation-in-part of application No. 16/362,665, filed on Mar. 24, 2019, now Pat. No. 11,081,606.
Application No. 18/129,865 is a continuation-in-part of application No. 17/802,335, filed on Aug. 25, 2022, now abandoned.
Application No. PCT/IL2023/051290 is a continuation-in-part of application No. 18/372,720, filed on Sep. 26, 2023.
Application No. 18/372,720 is a continuation of application No. PCT/IL2022/050339, filed on Mar. 29, 2022.
Application No. PCT/IL2022/050339 is a continuation-in-part of application No. PCT/IL2021/051202, filed on Oct. 8, 2021.
Application No. PCT/IL2021/051202 is a continuation-in-part of application No. PCT/IL2021/051269, filed on Oct. 27, 2021.
Application No. PCT/IL2021/051269 is a continuation-in-part of application No. PCT/IL2022/050030, filed on Jan. 10, 2022.
Application No. PCT/IL2022/050030 is a continuation-in-part of application No. 17/353,867, filed on Jun. 22, 2021, now Pat. No. 11,978,815.
Application No. 18/372,720 is a continuation-in-part of application No. 18/136,359, filed on Apr. 19, 2023.
Application No. 18/136,359 is a continuation of application No. PCT/IL2021/051269, filed on Oct. 27, 2021.
Application No. PCT/IL2021/051269 is a continuation-in-part of application No. 17/353,867, filed on Jun. 22, 2021, now Pat. No. 11,978,815.
Application No. 18/372,720 is a continuation-in-part of application No. 18/217,620, filed on Jul. 3, 2023.
Application No. 18/217,620 is a continuation of application No. PCT/IL2022/050030, filed on Jan. 10, 2022.
(60) Provisional application No. 62/785,282, filed on Dec. 27, 2018.
(60) Provisional application No. 62/785,282, filed on Dec. 27, 2018.
(60) Provisional application No. 62/982,536, filed on Feb. 27, 2020.
(60) Provisional application No. 63/088,535, filed on Oct. 7, 2020.
(60) Provisional application No. 63/106,666, filed on Oct. 28, 2020.
(60) Provisional application No. 63/167,660, filed on Mar. 30, 2021.
(60) Provisional application No. 63/435,255, filed on Dec. 25, 2022.

(51) Int. Cl. H02S 30/10; H02S 20/23; H02S 20/30; H02S 30/20; H02S 40/10

(52) U.S. Cl. CPC H02S 30/10; H02S 20/23; H02S 20/30; H02S 30/20; H02S 40/10

(57) ABSTRACT

Corrugated solar panels for improved installation and water-tight mounting. A solar panel includes: a central photovoltaic region, including one or more photovoltaic cells that are configured to convert light to electricity; and at least one corrugated non-planar region, that is attached to the central photovoltaic region, and that is configured to overlap a complementing corrugated non-planar region of another solar panel, and to enable nested mechanical attachment of that solar panel to the other solar panel. Optionally, the corrugated non-planar region is non-photovoltaic. Optionally, the corrugated non-planar region is photovoltaic. Optionally, the corrugated non-planar region is detachably attached to the central photovoltaic region. Optionally, the corrugated non-planar region is non-detachably attached to the central photovoltaic region.

### CROSS-REFERENCE TO RELATED APPLICATIONS

This patent application is a Continuation of PCT international application number PCT/IL2023/051290, having an international filing date of Dec. 20, 2023, which is hereby incorporated by reference in its entirety.

The above-mentioned PCT/IL2023/051290 claims priority and benefit from U.S. 63/435,255, filed on Dec. 25, 2022, which is hereby incorporated by reference in its entirety.

The above-mentioned PCT/IL2023/051290 is also a Continuation-in-Part (CIP) of, and claims benefit and/or priority from: patent application U.S. Ser. No. 18/129,865, filed on Apr. 2, 2023, which is hereby incorporated by reference in its entirety.

The above-mentioned U.S. Ser. No. 18/129,865 is a Continuation of PCT international patent application number PCT/IL2021/051202, having an international filing date of Oct. 7, 2021, which is hereby incorporated by reference in its entirety.

The above-mentioned PCT/IL2021/051202 claims priority and benefit: (i) from U.S. 63/088,535, filed on Oct. 7, 2020, which is hereby incorporated by reference in its entirety; and (ii) from U.S. Ser. No. 17/353,867, filed on Jun. 22, 2021, now patent number U.S. Pat. No. 11,978,815 (issued on May 7, 2024), which is hereby incorporated by reference in its entirety.

The above-mentioned U.S. Ser. No. 18/129,865 is also a Continuation-in-Part (CIP) of U.S. Ser. No. 17/353,867, filed on Jun. 22, 2021, now patent number U.S. Pat. No. 11,978,815 (issued on May 7, 2024), which is hereby incorporated by reference in its entirety.

The above-mentioned U.S. Ser. No. 17/353,867 is a Continuation-in-Part (CIP) of U.S. Ser. No. 16/362,665, filed on Mar. 24, 2019, now patent number U.S. Pat. No. 11,081,606 (issued on Aug. 3, 2021), which is hereby incorporated by reference in its entirety; which claims priority and benefit from U.S. 62/785,282, filed on Dec. 27, 2018, which is hereby incorporated by reference in its entirety.

The above-mentioned U.S. Ser. No. 17/353,867 is also a Continuation-in-Part (CIP) of PCT international application number PCT/IL2019/051416, having an international filing date of Dec. 26, 2019, which is hereby incorporated by reference in its entirety.

The above-mentioned PCT/IL2019/051416 claims priority and benefit: (i) from U.S. Ser. No. 16/362,665, filed on Mar. 24, 2019, now patent number U.S. Pat. No. 11,081,606 (issued on Aug. 3, 2021), which is hereby incorporated by reference in its entirety, and (ii) from U.S. 62/785,282, filed on Dec. 27, 2018, which is hereby incorporated by reference in its entirety.

The above-mentioned U.S. Ser. No. 18/129,865 is also a Continuation-in-Part (CIP) of U.S. Ser. No. 17/802,335, filed on Aug. 25, 2022, now abandoned, which is hereby incorporated by reference in its entirety; which is a National Stage of PCT international application number PCT/IL2021/050217, having an international filing date of Feb. 25, 2021, which is hereby incorporated by reference in its entirety; which claims priority and benefit from U.S. 62/982,536, filed on Feb. 27, 2020, which is hereby incorporated by reference in its entirety.

The above-mentioned PCT/IL2023/051290 is also a Continuation-in-Part (CIP) of, and claims benefit and/or priority from: patent application U.S. Ser. No. 18/372,720, filed on Sep. 26, 2023, which is hereby incorporated by reference in its entirety.

The above-mentioned U.S. Ser. No. 18/372,720 is a Continuation of PCT international application number PCT/IL2022/050339, having an international filing date of Mar. 29, 2022, which is hereby incorporated by reference in its entirety.

The above-mentioned PCT/IL2022/050339 claims priority and benefit from U.S. 63/167,660, filed on Mar. 30, 2021, which is hereby incorporated by reference in its entirety.

The above-mentioned PCT/IL2022/050339 also claims priority and benefit from (and is a Continuation-in-Part of) PCT international application number PCT/IL2021/051202, having an international filing date of Oct. 8, 2021, which is hereby incorporated by reference in its entirety.

The above-mentioned PCT/IL2022/050339 also claims priority and benefit from (and is a Continuation-in-Part of) PCT international application number PCT/IL2021/051269, having an international filing date of Oct. 27, 2021, which is hereby incorporated by reference in its entirety.

The above-mentioned PCT/IL2022/050339 also claims priority and benefit from (and is a Continuation-in-Part of) PCT international application number PCT/IL2022/050030, having an international filing date of Jan. 10, 2022, which is hereby incorporated by reference in its entirety.

The above-mentioned PCT/IL2022/050339 also claims priority and benefit from patent application U.S. Ser. No. 17/353,867, filed on Jun. 22, 2021, now patent number U.S. Pat. No. 11,978,815 (issued on May 7, 2024), which is hereby incorporated by reference in its entirety.

The above-mentioned U.S. Ser. No. 18/372,720 is also a Continuation-in-Part (CIP) of U.S. Ser. No. 18/136,359, filed on Apr. 19, 2023, which is hereby incorporated by reference in its entirety. The above-mentioned U.S. Ser. No. 18/136,359 is a Continuation of PCT international application number PCT/IL2021/051269, having an international filing date of Oct. 27, 2021, which is hereby incorporated by reference in its entirety. The above-mentioned PCT/IL2021/051269 claims priority and benefit: (i) from U.S. 63/106,666, filed on Oct. 28, 2020, which is hereby incorporated by reference in its entirety; and also, (ii) from U.S. Ser. No. 17/353,867, filed on Jun. 22, 2021, now patent number U.S. Pat. No. 11,978,815 (issued on May 7, 2024), which is hereby incorporated by reference in its entirety.

The above-mentioned U.S. Ser. No. 18/372,720 is also a Continuation-in-Part (CIP) of U.S. Ser. No. 18/217,620, filed on Jul. 3, 2023, which is hereby incorporated by reference in its entirety; which is a Continuation of the above-mentioned PCT international application number PCT/IL2022/050030, having an international filing date of Jan. 10, 2022, which is hereby incorporated by reference in its entirety.

### FIELD

Some embodiments relate to the field of solar panels and photovoltaic (PV) devices.

### BACKGROUND

The photovoltaic (PV) effect is the creation of voltage and electric current in a material upon exposure to light. It is a physical and chemical phenomenon.

The PV effect has been used in order to generate electricity from sunlight. For example, PV solar panels absorb sunlight or light energy or photons, and generate electricity through the PV effect.

### SUMMARY

Some embodiments provide corrugated solar panels that enable improved or efficient or rapid installation, and/or improved or efficient or rapid removal or replacement. In some embodiments, at least a central region of each solar panel is flexible and/or rollable and/or foldable; such that the solar panel as a whole is sufficiently flexible and mechanical durable to be formed or structured to have corrugated edge or a corrugated border or a corrugated frame or frame-member, along at least one side of the solar panel; to facilitate installation and/or removal and/or replacement and/or deployment and/or storage and/or stacking of solar panels. Some embodiments may particularly enable water-tight installation of adjacent solar panels or neighboring solar panels or bordering solar panels.

Some embodiments provide corrugated or “winged” solar panels for improved installation and water-tight mounting, as well as methods and systems for producing such solar panels. For example, a solar panel includes: a central photovoltaic region, including one or more photovoltaic cells that are configured to convert light to electricity; and at least one corrugated non-planar region, that is attached to the central photovoltaic region, and that is configured to overlap a complementing corrugated non-planar region of another solar panel, and to enable nested mechanical attachment of that solar panel to the other solar panel. Optionally, the corrugated non-planar region is non-photovoltaic. Optionally, the corrugated non-planar region is photovoltaic. Optionally, the corrugated non-planar region is detachably attached to the central photovoltaic region. Optionally, the corrugated non-planar region is non-detachably attached to the central photovoltaic region.

Some embodiments may provide other and/or additional benefits and/or advantages.

### BRIEF DESCRIPTION OF THE DRAWINGS

FIGS. 1A to 1D are schematic illustrations of several implementations of a corrugated solar panel, in accordance with some demonstrative embodiments.

FIG. 2A is a schematic illustration of a side-view of a corrugated solar panel, in accordance with some demonstrative embodiments.

FIG. 2B is a schematic illustration of a side-view of another corrugated solar panel, in accordance with some demonstrative embodiments.

FIG. 2C is a schematic illustration of a side-view of a stack of three corrugated solar panels, in accordance with some demonstrative embodiments.

FIG. 3A is a schematic illustration of a side-view of two corrugated solar panels, in a pre-installation position, in accordance with some demonstrative embodiments.

FIG. 3B is a schematic illustration of a side-view of two corrugated solar panels, in an installed position or installed arrangement, in accordance with some demonstrative embodiments.

FIG. 3C is a schematic illustration of a side-view of two corrugated solar panels, in an installed position or installed arrangement, tightly inter-connected to each other at the corrugated regions via an adhesive or glue or bonding agent or sealant or sealing agent, in accordance with some demonstrative embodiments.

FIG. 3D is a schematic illustration of a side-view of two corrugated solar panels, in an installed position or installed arrangement, tightly inter-connected to each other at the corrugated regions via mechanical connectors (e.g., screw, nail, nuts and bolts, male-female connector, industrial staple), in accordance with some demonstrative embodiments.

FIG. 3E is a schematic illustration of a side-view of two corrugated solar panels, in an installed position or installed arrangement, tightly inter-connected to each other at the corrugated regions via an adhesive and/or sealant and/or glue and/or bonding agent and/or sealing agent; and further mechanical mounted and attached an adhesive on top of a roof/ceiling/structure/substrate; in accordance with some demonstrative embodiments.

FIG. 3F is a schematic illustration of a side-view of two corrugated solar panels, in an installed position or installed arrangement, tightly inter-connected to each other at the corrugated regions via mechanical connectors; such that the mechanical connectors further connect the set of solar panels onto a roof/ceiling/structure/substrate; in accordance with some demonstrative embodiments.

FIG. 3G is a schematic illustration of a side-view of two corrugated solar panels, in an installed position or installed arrangement, using a combination of adhesive (and/or sealant or sealing agent) and mechanical connectors for mechanical mounting of the solar panels onto a roof/ceiling/structure/substrate; in accordance with some demonstrative embodiments.

FIGS. 4A to 4G are schematic illustrations of side-views of several other implementations of a corrugated solar panel, in accordance with some demonstrative embodiments.

FIG. 5A is a schematic illustration of a side-view of a single solar panel having three winged regions or three corrugated regions, in accordance with some demonstrative embodiments.

FIG. 5B is a schematic illustration of a side-view of another single solar panel having three winged regions or three corrugated regions, in accordance with some demonstrative embodiments.

### DETAILED DESCRIPTION OF SOME DEMONSTRATIVE EMBODIMENTS

The term “corrugated” as used herein may include, for example, a structure (e.g., a solar panel or a photovoltaic device) having at least one edge that is non-planar, that has a cross-section of a wave or a ridge or a wing; such that a plurality of such structures, when placed side by side, can partially overlap with one another, such that a first wave-portion or ridge-portion of a first panel rests exactly beneath (and supports thereon) a second wave-portion or ridge-portion of a second, adjacent, panel; and optionally also, such that an opposite wave-portion or ridge-portion of the second panel, rests exactly beneath (and supports thereon) a third wave-portion or ridge-portion of a third, adjacent, panel; and so forth.

For demonstrative purposes, some portions of the discussion herein may relate to a “central” region of the solar panel, which is photovoltaic and/or which includes photovoltaic cell(s); however, the term “central” is only a non-limiting example, and such photovoltaic region(s) of a solar panel need not necessarily be located at, or exactly at, the center of the solar panel; and such photovoltaic cell(s) may be located in non-central portions or regions of the solar panel, and/or may extend or may reach an edge of a solar panel, or the like.

The Applicant has realized that it may be beneficial to efficiently install solar panels, such as flexible and/or rollable and/or foldable and/or lightweight and/or thin solar panels, on top of roofs or slanted roofs or horizontal roofs or buildings or other structures; and particularly on structures that may not be able to support heavyweight or cumbersome traditional glass-covered solar panels. Such lightweight solar panels may be composed of photovoltaic element that are encapsulated between layers of polymeric sheets (thermoplastic and/or thermosetting), with or without reinforcement materials (e.g., glass fiber, glass fabrics, nets, carbon fibers).

Some embodiments provide a solar panel having an addition of a faceted or wave-like or ridge-like region or regions, located at one edge of the solar panel, or located at two opposite edges of the solar panel, or located at three edges of the solar panel, or located at all four edges of a generally-rectangular solar panel; or located at or along all the edges of a solar panel; or located along at least one edge of the solar panel; or located along at least one pair of opposite edges of a solar panel; or located along exactly one pair of opposite edges of a solar panel; or located along two pairs of opposite edges of a solar panel.

In a demonstrative embodiment, a solar panel is manufactured using polymeric sheets, which may be formed or structured into the required three-dimensional shape by a suitable production process, such as thermoforming or thermosetting. For example, a thermoforming process may use elevated temperature and heat to soften the relevant region of the solar panel, as well as mechanical force or a pressure difference on both sides of the solar panel to selectively deform the material and to make it acquire the desired three-dimensional structure. The process may be done in one or more steps using a male forming tool, a female forming tool, or a combination of male and female forming tools. In some embodiments, a single singular production step or a single production process is used, to simultaneously produce the central region of the solar panel and its faceted regions or edges or borders, as a singular integral or integrated article. In some embodiments, the faceted regions or edges or borders of the solar panel are non-detachably attached to the central region of the solar panel.

In some embodiments, only the central region of the solar panel, which occupies at least N percent of the total area of the solar panel, comprises photovoltaic cells that convert light into electricity; whereas, a border or frame or edge(s) of the solar panel, that feature the faceted regions or the corrugated regions, is formed of non-photovoltaic materials (e.g., plastic, glass, glass fiber, carbon, carbon fiber, thermoplastic materials, elastomers, rubber, or the like). In some embodiments, N is at least 75; or N is at least 80; or N is at least 85; or N is at least 90; or N is at lease 95; or N is at least 98. In some embodiments, N is 75; or N is 80; or Nis 85; or N is 90; or N is 95; or N is 98. In some embodiments, N is in the range of 75 to 99, or 75 to 98, or 75 to 95, or 75 to 90; or N is in the range of 80 to 99, or 80 to 98, or 80 to 99. In some embodiments, realized the Applicant, these particular proportions or ratio of the central region of the solar panel (which has PV cells) and the faceted frame/edges/border (that lack PV cells) provides an efficient result of generating electricity from light while also providing mechanical support and efficient installation/removal/mounting/removal/replacement capability.

In other embodiments, not only the central region of the solar panel, but rather the entirety of the corrugated solar panel, including its central region and including its corrugated regions and its faceted edges/border/frame, comprises photovoltaic cells that convert light into electricity. This may be achieved, for example, by structuring the entirety of the solar panel, which may be at least partially flexible/foldable/rollable, into the desired three-dimensional/faceted structure; optionally utilizing a thermoplastic/thermosetting process.

In another demonstrative embodiment, the faceted regions or edges or borders of the solar panel are attached to a solar panel in a secondary manufacturing step; for example, by gluing, bonding, adhesive tape, adhesive liquid, nuts and bolts, male-female connectors, or other mechanical connection mechanisms.

During installation or deployment or mounting of the solar panels onto a roof or a building or other structure, the facetted regions/edges/border/frame of such solar panels may be used to efficiently and rapidly attach the solar panels to such roof of building or other substrate, and/or to each other in a series or to form an elongated column or row or to form a matrix or array of mechanically interconnected solar panels. Such attachment or mounting or installation may be via adhesives, adhesive tape, adhesive liquid, glue, sealants, screws, nuts and bolts, screws, male-female connectors, industrial staplers or staples, and/or other attachment mechanisms or a combination thereof. In some embodiments, the mounting/installation of the solar panel(s) onto the roof/building/structure may be generally permanent or non-reversable, such that the solar panel(s) are not intended for removal; although even such installation or mounting may sometimes be reversed using the appropriate mechanical tools or equipment (e.g., pulling out nails or screws, forcibly detaching a glued panel, or the like). In other embodiments, the solar panel(s) are installed or mounted onto the roof/building/structure in a process that intentionally enables the solar panels, or at least some of them, to be detached or removed or replaced, in an efficient or rapid manner and without operably damaging the removed solar panel(s); such as, by using an adhesive that holds the solar panel in place but still enables efficient and non-damaging peeling off or separation or detachment, or by using male-and-female connectors that can later be detached or separated.

In some embodiments, installing two or more adjacent or neighboring solar panels, that partially overlap with each other at the facetted/corrugated regions or borders or frame, may create a water-tight seal or a water-proof seal or a sealing structure that entirely eliminates (or, that significantly reduces) water from penetrating below the solar panels.

In some embodiments, the faceted regions/edges/border/frame may optionally contain or comprise electrical conductors for the electrical connection of solar panels in series and/or in parallel. In such embodiments, the faceted regions/edges/border/frame may innovatively server multiple functional goals, such as: (A) to enable rapid and efficient installation of adjacent solar panels; (B) to provide mechanical connection among solar panels, which in turn may provide additional mechanical resilience (e.g., a solar panel that becomes slightly loose, may be held in place by its neighboring solar panels); (C) to provide electrical connection among solar panels, enabling to aggregate the electric voltage/the electric current that are generated by the solar panels from light through the photovoltaic effect; (D) to provide a water-tight sealant, or to improve the water-sealing capability of a plurality of such neighboring solar panels, and to eliminate or block or at least partially prevent leakage or dripping of water to an area or a structure beneath the solar panels; (E) to enable efficient or rapid removal/detachment/replacement of a one or more solar panels, since (in some implementations) only the faceted regions/edges/frame/border is glued to a structure and not the entirety of the solar panel and not the central region of the solar panel, thus requiring less mechanical force to remove and replace a solar panel, and thus reducing the risk that removal of a solar panel would damage its operable central region or its operable PV cells; (F) to enable rapid and efficient placement an alignment of solar panels during their installation process, such that a consecutive solar panel can be efficiently installed by rapidly placing its facet/ridge-shape/wave-shape region on top of the corresponding/compatible/complementing facet/ridge-shape/wave-shape region on top of an already-placed solar panel, or on top of another solar panel that is intended for installation; (G) to provide solar panels that can be stacked and/or nested efficiently, having complementing three-dimensional structure, enabling efficient storage and transport. Other advantages or benefits may be achieved; (H) to provide solar panels that may require a reduced number of nails/screws/staples/mechanical connectors in order to inter-connect them to each other and/or in order to mount them on top of a roof or building or other structure, since (for example) a single nail/screw/staple/mechanical connector can be used to penetrate through two nested and overlapping corrugated regions of two solar panels, and may optionally also penetrate into such roof or roof shingle; (I) optionally, to provide a three-dimensional channel between two corrugated regions or between two “wings” of the solar panel, that allows water or rain or dew or snow to flow thereon or therefrom, and/or to enable cleaning or self-cleaning of the solar panel or of portions thereof, and/or to enable efficient removal of rain or water or dust or sand or other materials from the photovoltaic regions of the solar panel.

Some embodiments provide a product or an article, comprising solar cells or PV cells that are embedded in a laminate of mostly polymeric layers; optionally including composite materials; wherein at least one edge of the article is structured to have at least one angled facet, to thereby facilitate installation/mounting and to provide other functional advantages as described.

In some embodiments, the faceted edge(s)/border/frame/region(s) of the solar panel are thermoformed using a combination of heat and pressure; or are heat-and-pressure thermoformed; such as, in a singular production process that integrally produces the photovoltaic region(s) of the solar panel and the faceted edge(s)/border/frame/region(s) of the solar panel.

In some embodiments, the faceted edge(s)/border/frame/region(s) of the solar panel are formed using mechanical force and/or pressure difference, at ambient conditions and without necessarily applying heat or heating the faceted region(s).

In some embodiments, faceted edge(s)/border/frame/region(s) of the solar panel are added or connected or attached to an already-produced solar panel or photovoltaic cell or PV cell array, in a secondary production step; and are not an integral part of the photovoltaic panel; and may optionally be detachably attached to the photovoltaic panel.

In some embodiments, the solar panel has faceted or angled or wave-shaped or ridge-shaped facet(s) at exactly one side of the solar panel, or at exactly one edge of the solar panel. In some embodiments, the solar panel has faceted or angled or wave-shaped or ridge-shaped facet(s) in at least one side of the solar panel, or in at least one edge of the solar panel.

In some embodiments, the solar panel has faceted or angled or wave-shaped or ridge-shaped facet(s) at exactly two sides of the solar panel, or at exactly two edges of the solar panel. In some embodiments, the solar panel has faceted or angled or wave-shaped or ridge-shaped facet(s) in at least two sides of the solar panel, or in at least two edges of the solar panel.

In some embodiments, the solar panel has faceted or angled or wave-shaped or ridge-shaped facet(s) at exactly two opposite sides of the solar panel, or at exactly two opposite edges of the solar panel. In some embodiments, the solar panel has faceted or angled or wave-shaped or ridge-shaped facet(s) in at least two opposite sides of the solar panel, or in at least two opposite edges of the solar panel.

In some embodiments, the solar panel has faceted or angled or wave-shaped or ridge-shaped facet(s) at exactly two neighboring or non-opposite sides of the solar panel, or at exactly two neighboring or non-opposite edges of the solar panel. In some embodiments, the solar panel has faceted or angled or wave-shaped or ridge-shaped facet(s) in at least two neighboring or non-opposite sides of the solar panel, or in at least two neighboring or non-opposite edges of the solar panel.

In some embodiments, the solar panel has faceted or angled or wave-shaped or ridge-shaped facet(s) at exactly three sides of the solar panel, or at exactly three edges of the solar panel. In some embodiments, the solar panel has faceted or angled or wave-shaped or ridge-shaped facet(s) in at least three sides of the solar panel, or in at least three edges of the solar panel.

In some embodiments, the solar panel has faceted or angled or wave-shaped or ridge-shaped facet(s) at exactly four sides of the solar panel, or at exactly four edges of the solar panel. In some embodiments, the solar panel has faceted or angled or wave-shaped or ridge-shaped facet(s) in at least four sides of the solar panel, or in at least four edges of the solar panel; such as, if the solar panel is shaped as a pentagon or hexagon or other polygon.

In some embodiments, the solar panel has faceted or angled or wave-shaped or ridge-shaped facet(s) in at least five sides of the solar panel, or in at least five edges of the solar panel; such as, if the solar panel is shaped as a pentagon or hexagon or other polygon having five or more edges.

In some embodiments, the solar panel has at least two sides or edges that are faceted; wherein a first side or edge has a faceted region of a first type, whereas a second side or edge has a faceted region of a second, different, type. For example, the first type may be wave-shaped, whereas the second type may be ridge-shaped or triangular. Additionally or alternatively, the first type may be larger or higher than the second type; such as, the first type having a maximum height of 5 centimeters, whereas the second type having a maximum height of 3 centimeters. Such non-identical facets/edges may serve various functional purposes; for example, to enable easier sliding or over-sliding or under-sliding of a first solar panel relative to a second solar panel, or to achieve other functional advantages that may exist when installing or deploying items articles that are generally similar but are not entirely symmetrical; or for indicating to an installer to place the longer/higher facets of solar panels such that they are oriented towards a top of a slanted roof, whereas smaller/shorter facets of the solar panels are facing downwardly away from the top of the slanted roof, as the upper facets may require more adhesive relative to the smaller facets; or for other purposes. In other embodiments, all the facets of a single solar panel have the same properties or characteristic, to provide an entirely symmetrical solar panel that can be installed efficiently even if rotated by 90 or 180 degrees.

In some embodiments, the number of angled facets on each side of the solar panel is the same. In other embodiments, the number of angled facets on each side of the solar panel is different.

In some embodiments, at least one edge of the solar panel has a facet at one angle. In other embodiments, at least one edge of the solar panel has two facets that are orientated at two respective angles. In other embodiments, at least one edge of the solar panel has three facets that are orientated at three respective angles. In other embodiments, at least one edge of the solar panel has four facets that are orientated at four respective angles. In other embodiments, at least one edge of the solar panel has more than four facets that are orientated at more than four respective angles.

Some embodiments provide a multiple-panel or a multi-panel system, comprising two or more solar panels as described above, having the same properties or structure, or having similar and complementing or compatible properties or structure; which are installed or mounted or mechanically interconnected side-by-side, with at least one overlapping facet or surface, or with at least one partially-overlapping facet or surface, that provides advantages such as facilitating installation, providing water sealant properties or water leakage prevention or providing a water-tight seal, providing tight mechanical connection, enabling efficient alignment and placement of neighboring panels, or the like.

In some embodiments, a plurality of such mechanically interconnected and partially overlapping solar panels can be mounted on top of a roof-less structure or a ceiling-less structure, or on top of a structure having a minimal/internal ceiling (e.g., made of sheet-rock or wood) and that lacks a roof; such that the combination or arrangement of such multiple solar panels provides an alternative to a roof, or functions as a roof, or protects the structure from rain and/or water and/or snow and/or dew and/or wind and/or humidity; for example, functioning as a stand-alone roof replacement or as a stand-alone roof by themselves, on top of four walls or four panels of a home, a mobile home, a shack, a toolshed, a warehouse, or the like. In some embodiments, such plurality of such mechanically interconnected and partially overlapping solar panels can be implemented as a portion of a roof, or as a sealant for a hole or aperture in a roof, or as a replacement for a roof-portion. In some embodiments, a plurality of such mechanically interconnected and partially overlapping solar panels can be used instead of roof shingles, or in addition to roof shingles, or may be surrounded by roof shingles, or may be mounted on top of roof shingles.

In some embodiments, the facetted region of such solar panel may contains or store or hold or protect or cover or cache or enclose therein, or have within it or beneath it, one or more electrical conductors or wires or cables, to provide electrical connection of photovoltaic panels in series and/or in parallel, and/or to aggregate or accumulate electric current and/or electric voltage that are generated via the photovoltaic effect, and/or to transfer-out or to transport away such generated electric current and/or electric voltage (e.g., to an electricity-storage device such as a battery or a power cell, or to an electricity-consuming device or appliance). In some embodiments, such electrical conductors or wires or cables may run through, or may run beneath, or may be laid within or beneath, such faceted or wave-like or ridged region of the solar panel(s).

In some embodiments, the faceted region of the solar panel is structured as a combination of straight lines or straight edges. In other embodiments, the faceted region of the solar panel is structured using only non-straight lines and non-planar regions; for example, using one or more curved regions, one or more concave regions, one or more convex regions, one or more wave shaped regions, a semi-circle or semi-sphere or dome region, a partial-circle or partial-sphere region, or the like; without using any straight or planar edges or surfaces at that faceted region of the solar panel that is intended to overlap with a compatible or corresponding or complementing faceted region of another solar panel; and while maintaining a three-dimensional non-planar structure that enables nesting of partially-overlapping solar panels. In other embodiments, the faceted region of the solar panel is structured as a combination of both: at least one straight lines or straight edge or planar surface, and at least one curved surface or concave surface or convex surface or non-planar surface.

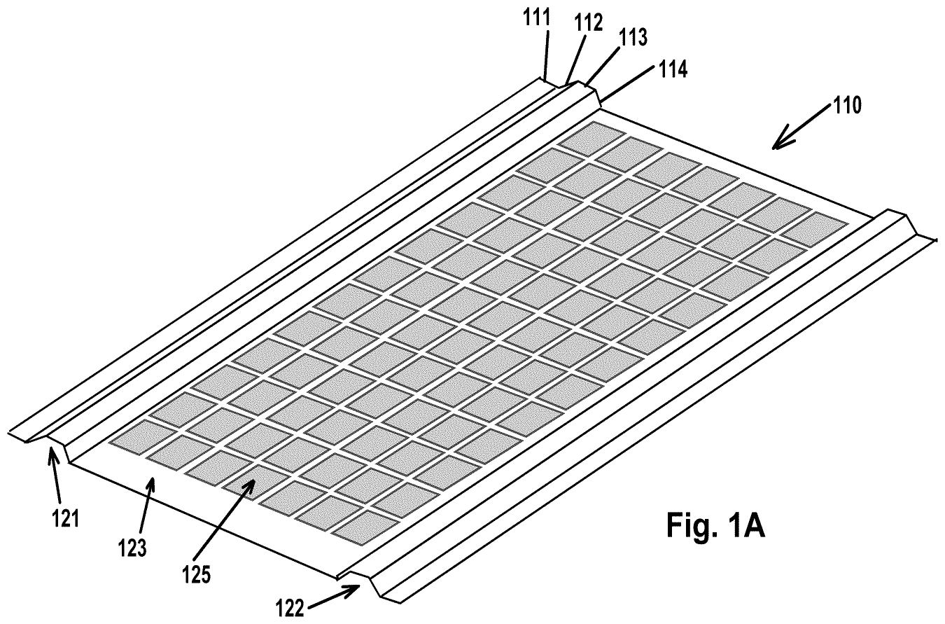

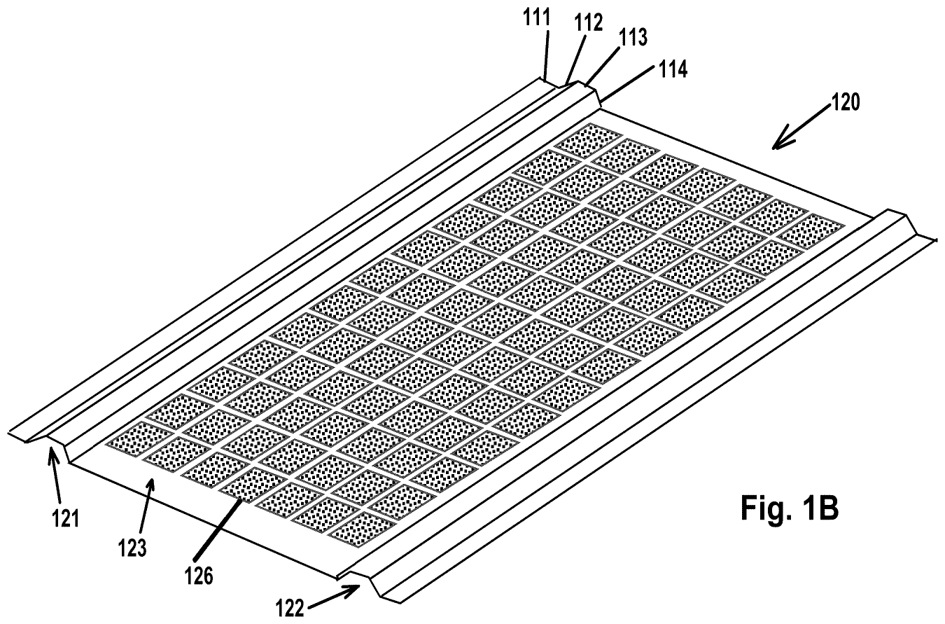

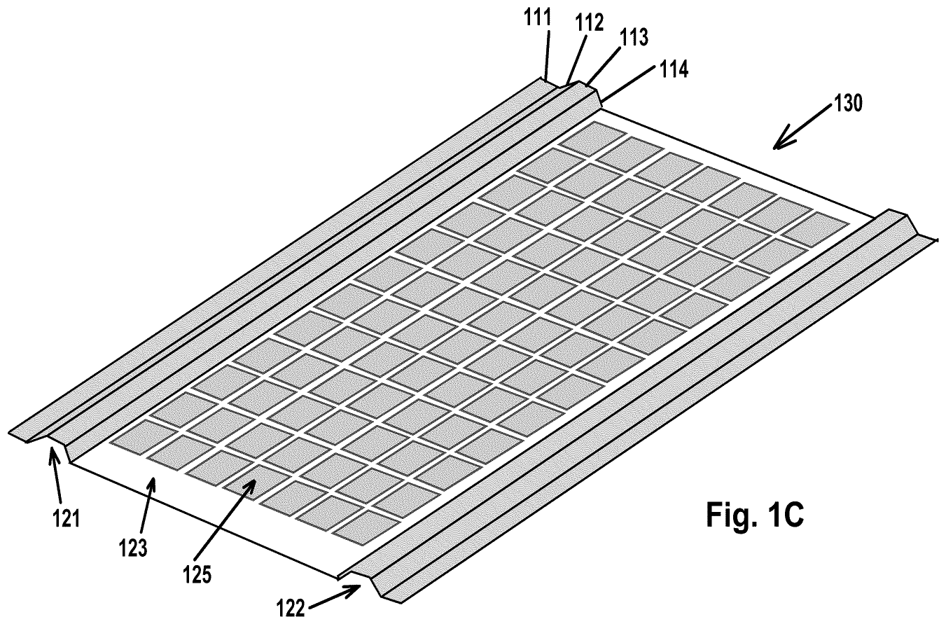

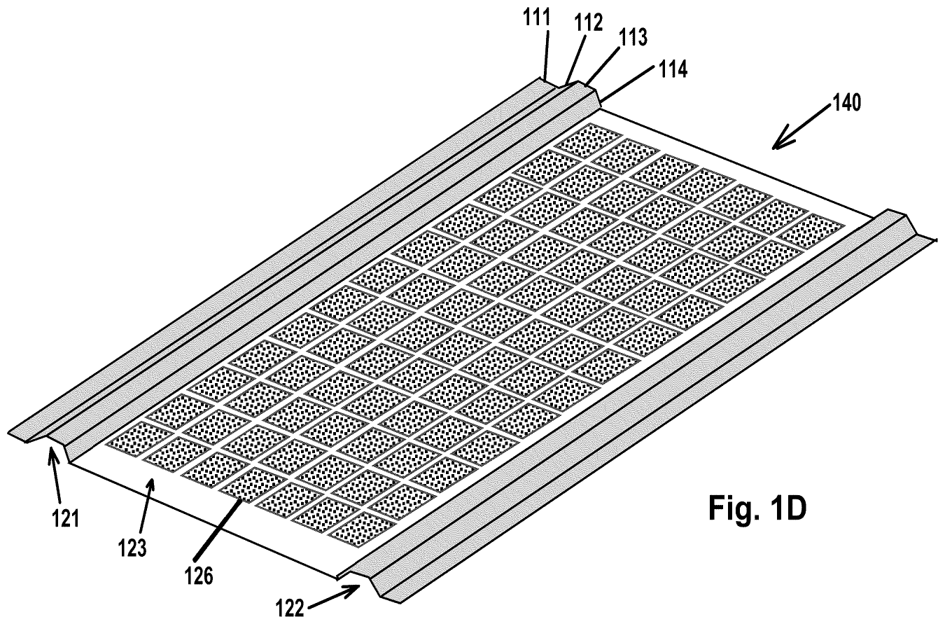

Reference is made to FIG. 1A, which is a schematic illustration of a corrugated solar panel 110, in accordance with some demonstrative embodiments. For demonstrative purposes, solar panel 110 is generally rectangular and has four sides; however, other polygon structure or non-polygon structures can be used in accordance with other embodiments, and/or other number of sides or edges may be used.

Solar panel 110 comprises a central region having a plurality of photovoltaic cells 125, each of them is configured to convert light into electricity. In a demonstrative implementation, the photovoltaic cells 125 are arranged as an array or a matrix; however, they may be arranged as a series or a string, or as a single column or a single row, or in other structure to achieve a particular shape. In some embodiments, the plurality of photovoltaic cells 125, or at least some of them, or most of them, or all of them, are interconnected mechanically; and/or are interconnected electrically, in series and/or in parallel, via conductors or wires or cables or electrodes that aggregate or accumulate the generated electric current and/or voltage, and/or that transport away or that output the generated electric current and/or voltage to an external recipient or to a nearby power cell or battery or power storage device or power consuming device. Optionally, a frame 123 or border may hold in place or may surround the plurality of photovoltaic cells 125.

For demonstrative purposes, two corrugated regions are shown at two opposite sides of the solar pane 110: corrugated region 121, and corrugated region 122. Other number of corrugated regions may be used per solar panel.

For demonstrative purposes, each corrugated region of solar panel 110 has four surfaces; for example, denoted as surfaces 111 to 114 in corrugated region 121.

In a demonstrative example, top surface 113 is parallel or is generally parallel to the plane of the plurality of photovoltaic cells 125; although in other embodiments, top surface 113 may be slanted relative to the plane of the plurality of photovoltaic cells 125.

In a demonstrative example, external surface 111 is parallel or is generally parallel to the plane of the plurality of photovoltaic cells 125, or is located at the same plane of the plurality of photovoltaic cells 125; although in other embodiments, external surface 111 may be slanted relative to the plane of the plurality of photovoltaic cells 125.

In a demonstrative example, surface 114 is slanted at an acute angle relative to the plane of the plurality of photovoltaic cells 125; other suitable angles may be used. Similarly, in a demonstrative example, surface 112 is slanted at an acute angle relative to the plane of the plurality of photovoltaic cells 125; other suitable angles may be used.

In accordance with some embodiments, the corrugated regions themselves (121 and 122) are non-photovoltaic, and they do not generate electricity from light.

In some embodiments, the plurality of photovoltaic cells 125 as an entire array are not flexible and are not foldable; and/or, each of the plurality of photovoltaic cells 125 is not flexible and is not foldable.

Reference is made to FIG. 1B, which is a schematic illustration of a corrugated solar panel 120, in accordance with some demonstrative embodiments. Solar panel 120 is generally similar to solar panel 110 described above; however, while the plurality of photovoltaic cells 125 of solar panel 110 are not flexible and not foldable, the plurality of plurality of photovoltaic cells 126 of solar panel 120 are flexible and/or foldable and/or rollable, and/or are non-brittle, and are configured to remain operable and to continue to convert light into electricity (without any degradation of efficiency, or with minimal and non-significant degradation of efficiency) if they are flexed or curved or un-flexed or folded or stretched or rolled or un-rolled. In some embodiments, each of the plurality of photovoltaic cells 126 is, by itself, generally flexible and/or rollable and/or foldable and/or non-brittle; and/or, the entirety of the array or matrix or arrangement of the plurality of photovoltaic cells 126 is flexible and/or rollable and/or foldable and/or non-brittle.

Reference is made to FIG. 1C, which is a schematic illustration of a corrugated solar panel 130, in accordance with some demonstrative embodiments. Solar panel 130 is generally similar to solar panel 110 described above; however, while the corrugated regions 121 and 122 of solar panel 110 are not photovoltaic devices by themselves, the corrugated regions 121 and 122 of solar panel 130 are implemented as photovoltaic regions or photovoltaic devices, that generate electricity from incoming light similar to the photovoltaic cells 125 that are in the central region of the solar panel. Accordingly, the corrugated regions of solar panel 130 provide an additional functionality of generating electricity, in addition to the other advantages and functionalities of corrugated regions as described above.

Reference is made to FIG. 1D, which is a schematic illustration of a corrugated solar panel 140, in accordance with some demonstrative embodiments. Solar panel 140 is generally similar to solar panel 120 described above; however, while the corrugated regions 121 and 122 of solar panel 120 are not photovoltaic devices by themselves, the corrugated regions 121 and 122 of solar panel 140 are implemented as photovoltaic regions or photovoltaic devices, that generate electricity from incoming light similar to the photovoltaic cells 126 that are in the central region of the solar panel. Accordingly, the corrugated regions of solar panel 140 provide an additional functionality of generating electricity, in addition to the other advantages and functionalities of corrugated regions as described above.

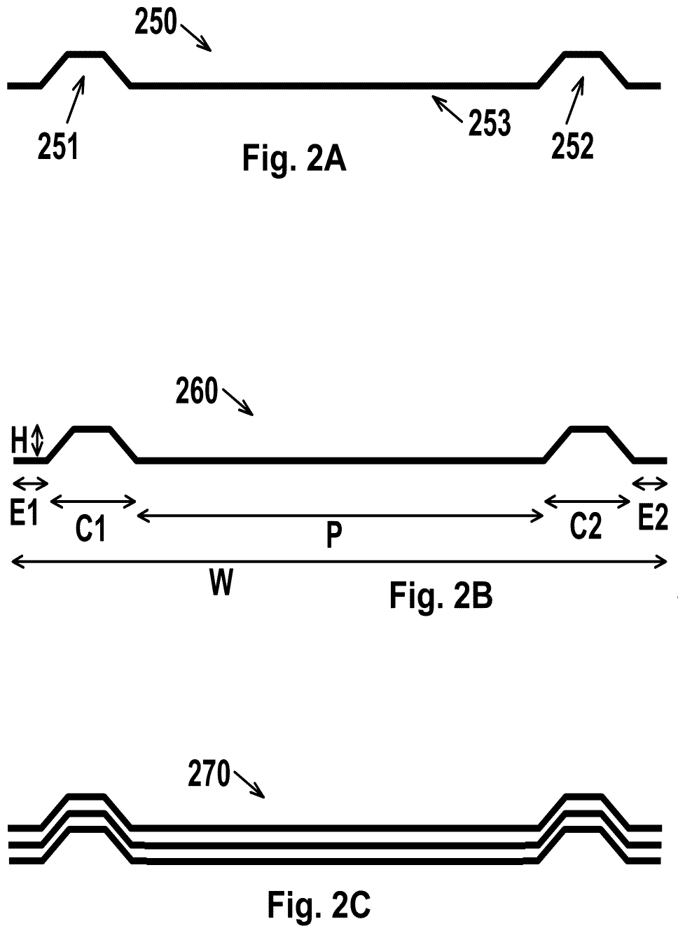

Reference is made to FIG. 2A, which is a schematic illustration of a side-view of a corrugated solar panel 250, in accordance with some demonstrative embodiments. It demonstrates a first corrugated region 251 along a first side of the solar panel; and a second corrugated region 252 along a second, opposite, side of the solar panel. In this demonstrative embodiment, the two corrugated regions 251 and 252 are generally identical and are generally symmetrical to each other; although other implementations may utilize two (or more) corrugated regions that are non-identical and/or non-symmetrical.

In some embodiments photovoltaic cell(s) region 253 is between the corrugated regions 251-252; wherein the corrugated regions 251-252 themselves do not have photovoltaic function and do not convert light into electricity. In other embodiments, corrugated region 251 and/or corrugated region 252 is (or are) by itself (or by themselves) photovoltaic device(s), that are configured to also convert light into electricity, in addition to their other functionalities as described above.

Reference is made to FIG. 2B, which is a schematic illustration of a side-view of another corrugated solar panel 260, in accordance with some demonstrative embodiments. It demonstrates some non-limiting example of the width of each component of the corrugated solar panel, or the ratio/s among such components. For example, an arrow E1 indicates the width of the external surface that protrudes externally or outwardly from the left-side corrugated region; and an arrow E2 indicates the width of the external surface that protrudes externally or outwardly from the right-side corrugated region. An arrow C1 indicates the net width of the left-side corrugated region, namely, the width of the left-side corrugated region that is not in the same plane as the central photovoltaic cell(s) 253. Similarly, an arrow C2 indicates the net width of the right-side corrugated region, namely, the width of the right-side corrugated region that is not in the same plane as the central photovoltaic cell(s) 253. An arrow P indicates the width of the region occupied by the central photovoltaic cell(s) 253. The longest arrow, W, indicates the total width of the solar panel; such that: W=E1+C1+P+C2+E2. An arrow H indicates a height of the corrugated regions relative to the top surface of the plane of the central photovoltaic cell(s) 253.

In some embodiments, for example: the height H is in the range of 25 to 60 millimeters; or in the range of 25 to 50 millimeters; or in the range of 30 to 60 millimeters; or in the range of 30 to 50 millimeters; or in the range of 35 to 50 millimeters; or in the range of 35 to 45 millimeters; or at least 25 millimeters; or at least 30 millimeters; or at least 35 millimeters; or at most 60 millimeters; or at most 50 millimeters.

In some embodiments, for example, the width C1 (or, the width C2) is, for example: in the range of 50 to 150 millimeters; or in the range of 60 to 150 millimeters; or in the range of 70 to 150 millimeters; or in the range of 50 to 125 millimeters; or in the range of 60 to 125 millimeters; or in the range of 70 to 125 millimeters; or in the range of 70 to 120 millimeters; or at least 50 millimeters; or at least 60 millimeters; or at least 70 millimeters; or at least 80 millimeters; or at least 90 millimeters; or at least 100 millimeters; or not more than 150 millimeters; or not more than 125 millimeters; or not more than 120 millimeters; or not more than 110 millimeters.

In some embodiments, for example, the width E1 (or, the width E2) is, for example: in the range of 10 to 50 millimeters; or in the range of 15 to 50 millimeters; or in the range of 20 to 50 millimeters; or in the range of 25 to 50 millimeters; or in the range of 15 to 40 millimeters; or in the range of 20 to 40 millimeters; or in the range of 25 to 40 millimeters; or in the range of 15 to 35 millimeters; or in the range of 20 to 35 millimeters; or at least 10 millimeters; or at least 15 millimeters; or at least 20 millimeters; or at least 25 millimeters; or at most 50 millimeters; or at most 40 millimeters; or at most 35 millimeters.

In some embodiments, for example, the width P is, for example: in the range of 20 to 1,200 millimeters; or in the range of 50 to 1,200 millimeters; or in the range of 100 to 1,200 millimeters; or in the range of 150 to 1,200 millimeters; or in the range of 200 to 1,200 millimeters; or in the range of 25 to 1,100 millimeters; or in the range of 25 to 1,000 millimeters; or in the range of 50 to 1,000 millimeters; or in the range of 100 to 1,000 millimeters; or in the range of 200 to 1,000 millimeters; or in the range of 500 to 1,250 millimeters; or at least 25 millimeters; or at least 50 millimeters; or at least 100 millimeters; or at most 1,500 millimeters; or at most 1,250 millimeters; or at most 1,200 millimeters; or at most 1,100 millimeters; or at most 1,000 millimeters.

Other suitable dimensions or ratios may be used, to achieve desired goals or to enable installation in or at a particular site or location.

In some embodiments, P is in a range of 75 to 99 percent of W. In some embodiments, P is in a range of 80 to 99 percent of W. In some embodiments, P is in a range of 85 to 99 percent of W. In some embodiments, P is in a range of 90 to 99 percent of W. In some embodiments, P is in a range of 95 to 99 percent of W. In some embodiments, P is in a range of 75 to 95 percent of W. In some embodiments, P is in a range of 75 to 90 percent of W. In some embodiments, The Applicant has realized that the above-mentioned demonstrative ratios may provide an efficient structure that both (i) efficiently generates electricity from light by having a sufficiently-large central region of photovoltaic cell(s), and also (ii) still enables efficient and rapid and reliable installation or mounting or interconnection of such solar panels by using the corrugated regions.

In some embodiments, each of C1 or C2 is in a range of 1 to 12 percent of W. In some embodiments, each of C1 or C2 is in a range of 1 to 10 percent of W. In some embodiments, each of C1 or C2 is in a range of 1 to 8 percent of W. In some embodiments, each of C1 or C2 is in a range of 1 to 5 percent of W. In some embodiments, each of C1 or C2 is in a range of 1 to 3 percent of W. The Applicant has realized that the above-mentioned demonstrative ratios may provide an efficient structure that both (i) efficiently generates electricity from light by having a sufficiently-large central region of photovoltaic cell(s), and also (ii) still enables efficient and rapid and reliable installation or mounting or interconnection of such solar panels by using the corrugated regions.

In some embodiments, each of E1 or E2 is in a range of 1 to 10 percent of W. In some embodiments, each of E1 or E2 is in a range of 1 to 8 percent of W. In some embodiments, each of E1 or E2 is in a range of 1 to 5 percent of W. In some embodiments, each of E1 or E2 is in a range of 1 to 3 percent of W. The Applicant has realized that the above-mentioned demonstrative ratios may provide an efficient structure that both (i) efficiently generates electricity from light by having a sufficiently-large central region of photovoltaic cell(s), and also (ii) still enables efficient and rapid and reliable installation or mounting or interconnection of such solar panels by using the corrugated regions.

In some embodiments, E1 and C1 together are in a range of 1 to 12 percent of P. In some embodiments, E1 and C1 together are in a range of 1 to 10 percent of P. In some embodiments, E1 and C1 together are in a range of 1 to 8 percent of P. In some embodiments, E1 and C1 together are in a range of 1 to 5 percent of P. In some embodiments, E1 and C1 together are in a range of 1 to 3 percent of P. In some embodiments, similar or identical ratios may be used with regard to E2 and C2 together, relative to P. The Applicant has realized that the above-mentioned demonstrative ratios may provide an efficient structure that both (i) efficiently generates electricity from light by having a sufficiently-large central region of photovoltaic cell(s), and also (ii) still enables efficient and rapid and reliable installation or mounting or interconnection of such solar panels by using the corrugated regions.

In some embodiments, H is in a range of 5 to 100 millimeters. In some embodiments, H is in a range of 5 to 80 millimeters. In some embodiments, H is in a range of 5 to 60 millimeters. In some embodiments, H is in a range of 5 to 50 millimeters. In some embodiments, H is in a range of 5 to 40 millimeters. In some embodiments, H is in a range of 5 to 30 millimeters. In some embodiments, H is in a range of 5 to 25 millimeters. In some embodiments, H is in a range of 5 to 20 millimeters. In some embodiments, H is in a range of 5 to 15 millimeters. In some embodiments, H is in a range of 5 to 10 millimeters. In some embodiments, H is in a range of 10 to 100 millimeters. In some embodiments, H is in a range of 10 to 80 millimeters. In some embodiments, H is in a range of 10 to 50 millimeters. In some embodiments, H is in a range of 10 to 30 millimeters. In some embodiments, H is in a range of 20 to 100 millimeters. In some embodiments, H is in a range of 20 to 80 millimeters. In some embodiments, H is in a range of 0.1 to 10 percent of W. In some embodiments, H is in a range of 0.1 to 8 percent of W. In some embodiments, H is in a range of 0.1 to 5 percent of W. In some embodiments, H is in a range of 0.1 to 2 percent of W. In some embodiments, H is in a range of 0.1 to 1 percent of W. In some embodiments, H is in a range of 1 to 10 percent of W. In some embodiments, H is in a range of 1 to 8 percent of W. In some embodiments, H is in a range of 1 to 5 percent of W. In some embodiments, H is in a range of 1 to 3 percent of W. The Applicant has realized that the above-mentioned demonstrative ratios may provide an efficient structure that both (i) efficiently generates electricity from light by having a sufficiently-large central region of photovoltaic cell(s), and also (ii) still enables efficient and rapid and reliable installation or mounting or interconnection of such solar panels by using the corrugated regions.

In some embodiments, the thickness of the central photovoltaic cell(s) is denoted K. In some embodiments, the corrugated region protrudes upwardly and reaches an additional height of one more K, relative to the top surface of the central photovoltaic cell(s). In other embodiments, the corrugated region protrudes upwardly and reaches an additional height of 2 times K, relative to the top surface of the central photovoltaic cell(s). In other embodiments, the corrugated region protrudes upwardly and reaches an additional height of 3 times K, relative to the top surface of the central photovoltaic cell(s). In other embodiments, the corrugated region protrudes upwardly and reaches an additional height of 4 times K, relative to the top surface of the central photovoltaic cell(s). In other embodiments, the corrugated region protrudes upwardly and reaches an additional height of 5 times K, relative to the top surface of the central photovoltaic cell(s). In other embodiments, the corrugated region protrudes upwardly and reaches an additional height of 10 times K, relative to the top surface of the central photovoltaic cell(s). In other embodiments, the corrugated region protrudes upwardly and reaches an additional height of 20 times K, relative to the top surface of the central photovoltaic cell(s). In other embodiments, the corrugated region protrudes upwardly and reaches an additional height of 30 times K, relative to the top surface of the central photovoltaic cell(s). In other embodiments, the corrugated region protrudes upwardly and reaches an additional height of 50 times K, relative to the top surface of the central photovoltaic cell(s). In other embodiments, the corrugated region protrudes upwardly and reaches an additional height of 80 times K, relative to the top surface of the central photovoltaic cell(s). The Applicant has realized that the above-mentioned demonstrative ratios may provide an efficient structure that both (i) efficiently generates electricity from light by having a sufficiently-large central region of photovoltaic cell(s), and also (ii) still enables efficient and rapid and reliable installation or mounting or interconnection of such solar panels by using the corrugated regions.

In some embodiments, the thickness of the central photovoltaic cell(s) is denoted K. In some embodiments, the corrugated region protrudes upwardly and reaches an additional height of at least one more K, relative to the top surface of the central photovoltaic cell(s). In other embodiments, the corrugated region protrudes upwardly and reaches an additional height of at least 2 times K, relative to the top surface of the central photovoltaic cell(s). In other embodiments, the corrugated region protrudes upwardly and reaches an additional height of at least 3 times K, relative to the top surface of the central photovoltaic cell(s). In other embodiments, the corrugated region protrudes upwardly and reaches an additional height of at least 4 times K, relative to the top surface of the central photovoltaic cell(s). In other embodiments, the corrugated region protrudes upwardly and reaches an additional height of at least 5 times K, relative to the top surface of the central photovoltaic cell(s). In other embodiments, the corrugated region protrudes upwardly and reaches an additional height of at least 10 times K, relative to the top surface of the central photovoltaic cell(s). In other embodiments, the corrugated region protrudes upwardly and reaches an additional height of at least 20 times K, relative to the top surface of the central photovoltaic cell(s). In other embodiments, the corrugated region protrudes upwardly and reaches an additional height of at least 30 times K, relative to the top surface of the central photovoltaic cell(s). In other embodiments, the corrugated region protrudes upwardly and reaches an additional height of at least 50 times K, relative to the top surface of the central photovoltaic cell(s). In other embodiments, the corrugated region protrudes upwardly and reaches an additional height of at least 80 times K, relative to the top surface of the central photovoltaic cell(s). The Applicant has realized that the above-mentioned demonstrative ratios may provide an efficient structure that both (i) efficiently generates electricity from light by having a sufficiently-large central region of photovoltaic cell(s), and also (ii) still enables efficient and rapid and reliable installation or mounting or interconnection of such solar panels by using the corrugated regions.

In some embodiments, the thickness of the central photovoltaic cell(s) is denoted K, and may be very thin; for example, 1 millimeter, or 2 millimeters, or 3 millimeters, or not more than 5 millimeters. In some embodiments, the corrugated region protrudes upwardly and reaches an additional height that is in a range of K and 2 times K, relative to the top surface of the central photovoltaic cell(s). In other embodiments, the corrugated region protrudes upwardly and reaches an additional height that is in a range of K and 3 times K, relative to the top surface of the central photovoltaic cell(s). In other embodiments, the corrugated region protrudes upwardly and reaches an additional height that is in a range of K and 4 times K, relative to the top surface of the central photovoltaic cell(s). In other embodiments, the corrugated region protrudes upwardly and reaches an additional height that is in a range of K and 5 times K, relative to the top surface of the central photovoltaic cell(s). In other embodiments, the corrugated region protrudes upwardly and reaches an additional height that is in a range of K and 10 times K, relative to the top surface of the central photovoltaic cell(s). In other embodiments, the corrugated region protrudes upwardly and reaches an additional height that is in a range of K and 20 times K, relative to the top surface of the central photovoltaic cell(s). In other embodiments, the corrugated region protrudes upwardly and reaches an additional height that is in a range of K and 30 times K, relative to the top surface of the central photovoltaic cell(s). In other embodiments, the corrugated region protrudes upwardly and reaches an additional height that is in a range of K and 50 times K, relative to the top surface of the central photovoltaic cell(s). In other embodiments, the corrugated region protrudes upwardly and reaches an additional height that is in a range of K and 80 times K, relative to the top surface of the central photovoltaic cell(s). The Applicant has realized that the above-mentioned demonstrative ratios may provide an efficient structure that both (i) efficiently generates electricity from light by having a sufficiently-large central region of photovoltaic cell(s), and also (ii) still enables efficient and rapid and reliable installation or mounting or interconnection of such solar panels by using the corrugated regions.

Reference is made to FIG. 2C, which is a schematic illustration of a side-view of a stack 270 of three corrugated solar panels, in accordance with some demonstrative embodiments. It demonstrates that a plurality of discrete corrugated solar panels can be efficiently stacked and/or nested, for efficient and reduced-volume storage and transportation. For purposes of clarity, the three corrugated solar panels are shown as having a small gap among them, to show each of the solar panel discretely; however, in real-life usage, the plurality of corrugated solar panels may be stacked and/or nested such that no air gap, or almost no air gap(s), remain among them.

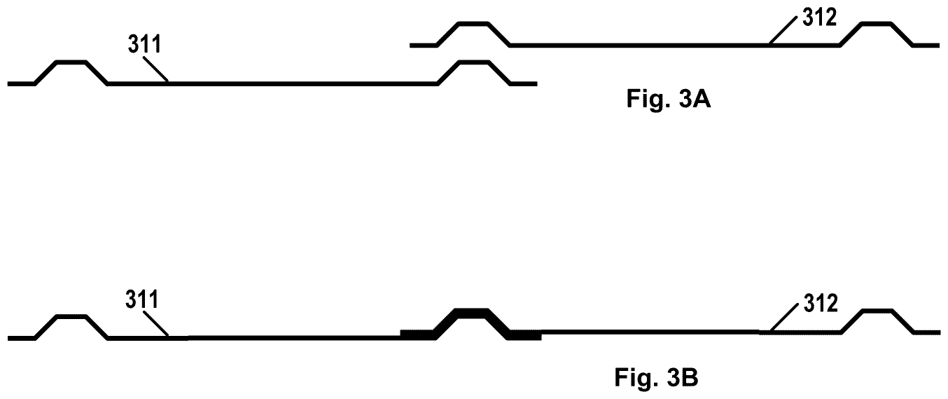

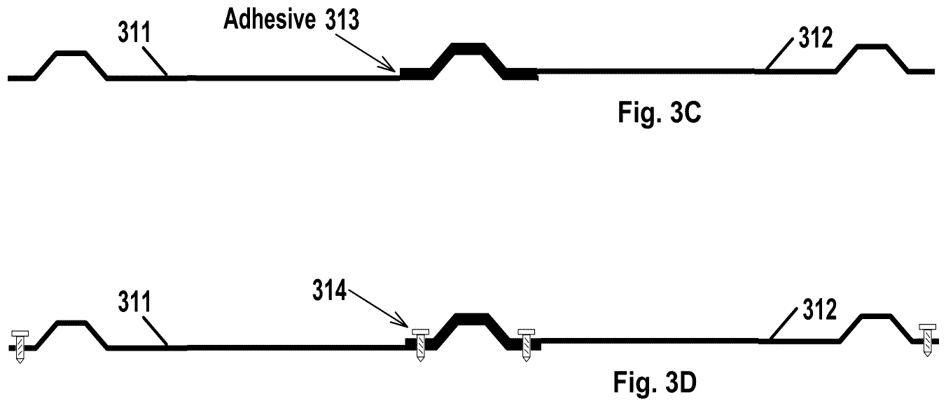

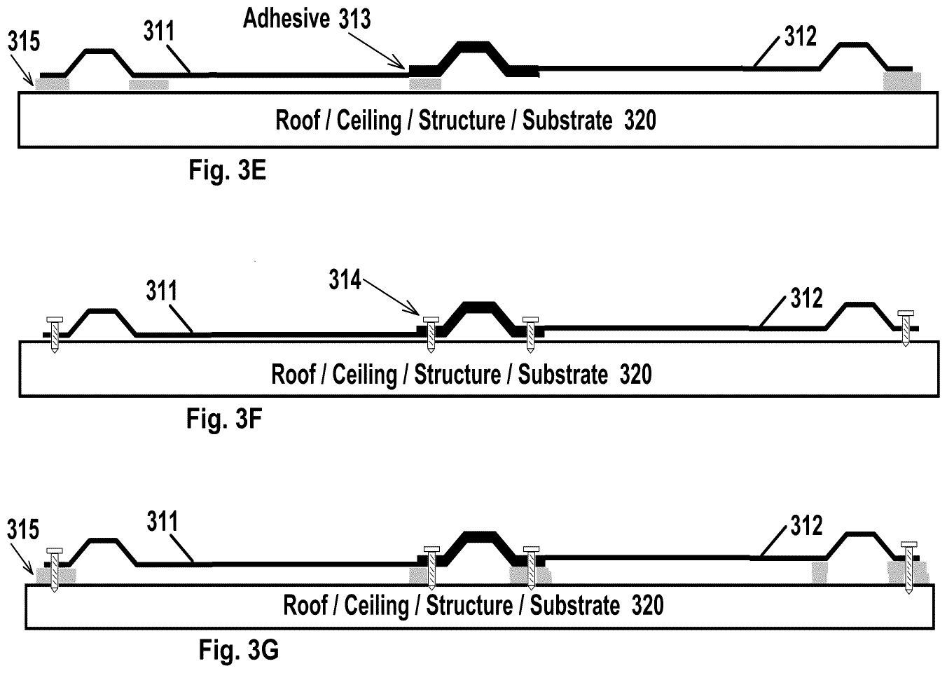

Reference is made to FIG. 3A, which is a schematic illustration of a side-view of two corrugated solar panels 311-312, in a pre-installation position, in accordance with some demonstrative embodiments. The two corrugated solar panels 311-312 are shown as entirely separate from each other, prior to their mounting or installation or inter-connection. In order to install or mount or inter-connect them, an initial step is to place them in partially-overlapping positions; such that, for example, the right-side corrugated region of solar panel 311 is located beneath the left-side corrugated region of solar panel 312; and such that the two solar panels 311-312 are generally parallel to each other.

Reference is made to FIG. 3B, which is a schematic illustration of a side-view of two corrugated solar panels 311-312, in an installed position or installed arrangement, in accordance with some demonstrative embodiments. The right-side corrugated region of solar panel 311 is tightly connected beneath the left-side corrugated region of solar panel 312; such that the two solar panels 311-312 are now tightly connected to each other at those partially-overlapping corrugated regions.

Reference is made to FIG. 3C, which is a schematic illustration of a side-view of two corrugated solar panels 311-312, in an installed position or installed arrangement, tightly inter-connected to each other at the corrugated regions via an adhesive 313 or glue or bonding agent or sealant or sealing agent, in accordance with some demonstrative embodiments.

Reference is made to FIG. 3D, which is a schematic illustration of a side-view of two corrugated solar panels 311-312, in an installed position or installed arrangement, tightly inter-connected to each other at the corrugated regions via mechanical connectors 314 (e.g., screw, nail, nuts and bolts, male-female connector, industrial staple), in accordance with some demonstrative embodiments.

Reference is made to FIG. 3E, which is a schematic illustration of a side-view of two corrugated solar panels 311-312, in an installed position or installed arrangement, tightly inter-connected to each other at the corrugated regions via an adhesive 313 and/or sealant and/or glue and/or bonding agent and/or sealing agent; and further mechanical mounted and attached an adhesive 315 on top of a roof/ceiling/structure/substrate 320; in accordance with some demonstrative embodiments. For clarity, the adhesive 315 or sealant is shown as a thick gray layer; however, in real-life implementations, the adhesive 315 or sealant may become or may be thin, such that the solar panels are tightly attached to the roof/ceiling/structure/substrate 320, without leaving an air gap, or while leaving a minimal air gap (e.g., 1 or 2 millimeters) in some regions.

Reference is made to FIG. 3F, which is a schematic illustration of a side-view of two corrugated solar panels 311-312, in an installed position or installed arrangement, tightly inter-connected to each other at the corrugated regions via mechanical connectors 314; such that the mechanical connectors further connect the set of solar panels onto a roof/ceiling/structure/substrate 320; in accordance with some demonstrative embodiments. For example, the mechanical connectors (e.g., nail, screw, industrial staple, or the like) may partially penetrate also into the roof/ceiling/structure/substrate 320. For clarity, the mechanical connectors 315 are shown with short gaps beneath them, to discretely show the components of the arrangement; however, in real-life implementations, the entirely arrangement may be tightly attached, such that the solar panels are tightly attached to the roof/ceiling/structure/substrate 320, without leaving an air gap, or while leaving a minimal air gap (e.g., 1 or 2 millimeters) in some regions.

Reference is made to FIG. 3G, which is a schematic illustration of a side-view of two corrugated solar panels 311-312, in an installed position or installed arrangement, using a combination of adhesive 315 (and/or sealant or sealing agent) and mechanical connectors 314 for mechanical mounting of the solar panels onto a roof/ceiling/structure/substrate 320; in accordance with some demonstrative embodiments. For clarity, the adhesive 315 (and/or sealant or sealing agent) is shown as a thick gray layer; however, in real-life implementations, the adhesive 315 (and/or sealant or sealing agent) may become or may be thin, such that the solar panels are tightly attached to the roof/ceiling/structure/substrate 320, without leaving an air gap, or while leaving a minimal air gap (e.g., 1 or 2 millimeters) in some regions. Optionally, additional adhesive 313 and/or sealant or sealing agent may be used between the corrugated regions of the solar panels, to further attach them to each other and to further improve their gap-less or gap-free attachment to each other or their sealant properties.

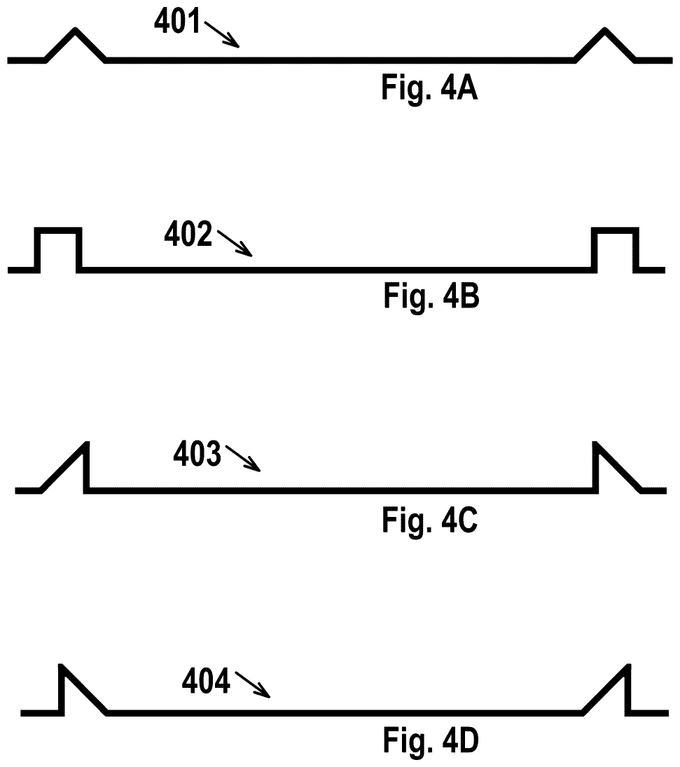

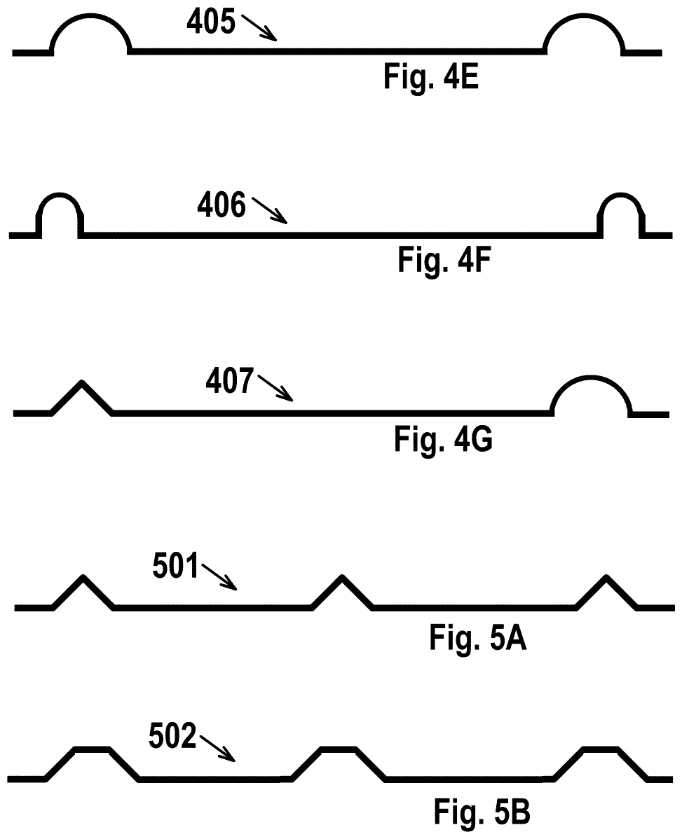

Reference is made to FIG. 4A, which is a schematic illustration of a side-view of another corrugated solar panel 401, in accordance with some demonstrative embodiments. For example, each of the corrugated regions has a triangular or an arrow-head cross-section, or has a protrusion comprised of two generally-flat and slanted panels or surfaces, as demonstrated.

Reference is made to FIG. 4B, which is a schematic illustration of a side-view of another corrugated solar panel 402, in accordance with some demonstrative embodiments. For example, each of the corrugated regions has a rectangular or square cross-section, or has a protrusion comprised of three generally-flat panels or surfaces that are generally perpendicular to each other, as demonstrated.

Reference is made to FIG. 4C, which is a schematic illustration of a side-view of another corrugated solar panel 403, in accordance with some demonstrative embodiments. For example, each of the corrugated regions has a right-triangle cross-section, or has a protrusion comprised of two generally-flat panels or surfaces, one of which is generally perpendicular to the plane of the photovoltaic cells(s), and the other one being slanted relative thereto, as demonstrated.

Reference is made to FIG. 4D, which is a schematic illustration of a side-view of another corrugated solar panel 404, in accordance with some demonstrative embodiments. For example, each of the corrugated regions has a right-triangle cross-section, or has a protrusion comprised of two generally-flat panels or surfaces, one of which is generally perpendicular to the plane of the photovoltaic cells(s), and the other one being slanted relative thereto, as demonstrated.

Reference is made to FIG. 4E, which is a schematic illustration of a side-view of another corrugated solar panel 405, in accordance with some demonstrative embodiments. For example, each of the corrugated regions has a half-sphere or a dome-shaped cross-section, or has a protrusion structured as half-sphere or partial-sphere or dome, as demonstrated.

Reference is made to FIG. 4F, which is a schematic illustration of a side-view of another corrugated solar panel 406, in accordance with some demonstrative embodiments. For example, each of the corrugated regions is structured to have planar sub-regions and curved or non-planar sub-regions, such as a half-sphere or dome on top of a cylindrical protrusion, as demonstrated.

Reference is made to FIG. 4G, which is a schematic illustration of a side-view of another corrugated solar panel 407, in accordance with some demonstrative embodiments. For example, a first corrugated region of solar panel 407 has a first structure having a second size or volume or height or width; whereas, a second corrugated region of the same solar panel 407 has a second, different, structure having a second, different, size or volume or height or width; or such that the two corrugated regions of the same solar panel 407 differ from each other by at least one property or characteristics.

Reference is made to FIG. 5A, which is a schematic illustration of a side-view of another corrugated solar panel 501, in accordance with some demonstrative embodiments. For example, it includes three corrugated regions, or three “wings” or three “winged” regions, or three upwardly-protruding regions. For example, two of the corrugated regions are at or along the edges or sides of the solar panel; whereas another corrugated region is generally parallel to them and is located within the central region of the solar panel. In some embodiments, that central corrugated region is photovoltaic, and can convert light into electricity. In some embodiments, that central corrugated region is an intentional spatial deformation of the central photovoltaic region of the solar panel, that provides to that central region its unique structure that enables nesting and stacking at that region as well. In the demonstrative example of solar panel 501, each of the three corrugated regions is generally triangular, or has a shape of an upside-down V. In other embodiments, more than three corrugated regions may be formed in one solar panel; for example, by forming two or three or other numbers of “central” or non-edge or non-border corrugated regions, along the central photovoltaic region.

Reference is made to FIG. 5B, which is a schematic illustration of a side-view of another corrugated solar panel 502, in accordance with some demonstrative embodiments. For example, it includes three corrugated regions, or three “wings” or three “winged” regions, which are generally trapezoid shaped.

### Additional/Optional Features:

In some embodiments, a solar cell or solar panel or PV device that is utilized may be an autonomously flexible and/or rollable and/or foldable solar cell, that does not break and does not brittle when flexed or curved or bent or folded or rolled, and that is resilient to mechanical forces, and that can autonomously absorb and/or dissipate and/or withstand mechanical forces and mechanical shocks; for example, by being singulated or segmented or grooved or trenched with non-transcending gaps or “blind gaps” or craters or grooves or trenches, that penetrate some—but not all-of the thickness (or the depth) of a silicon layer or a semiconductor body or a semiconductor wafer; and optionally by having filler material(s) in such grooves or trenches or non-transcending gaps or non-transcending craters, to further absorb and/or dissipate mechanical forces and shocks.

Optionally, some embodiments may be utilized in conjunction with PV devices and/or solar panels and/or components and/or methods that are described in patent number U.S. Pat. No. 11,081,606, titled “Flexible and rollable photovoltaic cell having enhanced properties of mechanical impact absorption”, which is hereby incorporated by reference in its entirety; and/or in conjunction with components, structures, devices, methods, systems and/or techniques that are described in patent application number U.S. Ser. No. 17/353,867, filed on Jun. 22, 2021, published as US 2021/0313478 A1, which is hereby incorporated by reference in its entirety; and/or with solar panels or solar cells or PV devices that are singulated or segmented or trenched or grooved, or that are flexible and/or rollable and/or foldable, and/or that include “blind gaps” or non-transcending gaps or craters. Some embodiments may provide a flexible and rollable PV cell or solar cell; wherein a silicon body or semiconductor body or semiconductor substrate or semiconductor wafer has non-transcending craters or “blind gaps” that penetrate into between 75 percent and 99 percent of a total thickness of the semiconductor body (or wafer, or substrate), and that do not penetrate into an entirety of the total thickness of the semiconductor body (or wafer, or substrate); wherein said non-transcending craters or “blind gaps” increase flexibility/or and mechanical resilience and/or mechanical shock absorption of the PV cell. In some embodiments, some, or most, or all of the non-transcending craters or “blind gaps” contain a filler material having mechanical force absorption properties, which provides mechanical shock absorption properties and/or mechanical force dissipation properties to the PV cell.

In some embodiments, each of the solar cells is rollable and flexible by itself; and is a single PV device or is a single PV article, that is comprised of a single semiconductor substrate or a single semiconductor wafer or a single semiconductor body; which is monolithic, e.g., is currently, and has been, a single item or a single article or a single component that was formed as (and remained) a single component; such that each solar cell is not formed as a collection or two or more separate units or as a collection of two or more entirely-separated or entirely-discrete or entirely-gapped units that were arranged or placed together in proximity to each other yet onto a metal foil or onto a metal film or onto a flexible or elastic foil or film.

In some embodiments, each single solar cell that is flexible and rollable by itself, is not a collection and is not an arrangement and is not an assembly of multiple discrete solar cells of PV modules, that each one of them has its own discrete and fully separated semiconductor substrate and/or its own discrete and fully separated semiconductor wafer and/or its own discrete and fully separated semiconductor body, and that have been merely placed to assembled or arranged together (or mounted together, or connected together) onto or beneath a flexible foil or a flexible film; but rather, the each single solar cell has a single unified semiconductor substrate or semiconductor body or semiconductor wafer that is common to, and is shared by, all the sub-regions or areas or portions of that single solar cell which includes therein (in that unified single semiconductor substrate or wafer or body) those non-transcending craters or non-transcending gaps or “blind gaps” that penetrate only from one side (and not from both sides), which do not reach all the way through and do not reach all the way to the other side of the unified single semiconductor substrate or wafer or body.

In some embodiments, each solar cell may be, or may include, a mono-crystalline PV cell or solar panel or solar cell, a poly-crystalline PV cell or solar panel or solar cell, a flexible PV cell or solar cell that is an Interdigitated Back Contact (IBC) solar cell having said semiconductor wafer with said set of non-transcending gaps, and/or other suitable type of PV cell or solar cell.

Some portions of the discussion above and/or herein may relate to regions or segments or areas, of the semiconductor body or substrate or wafer (or PV cell, or PV device); yet those “segments” are still touching each other and/or inherently connected to each other and/or non-separated from each other, as those “segments” are still connected by at least a thin portion or a thin bottom-side surface of the semiconductor substrate (or wafer, or body), which still holds and includes at least 1 (or at least 2, or at least 3, or at least 5, or at least 10, or at least 15, or at least 20, or at least 25, or at least 33; but not more than 50, or not more than 40) percent of the entire depth or the entire thickness (or the maximum thickness or depth) of the semiconductor substrate or body or wafer; as those “segments” are still connected at their base through such thin layer, and those “segments” have between them (or among them) the non-transcending gaps or the “blind gaps” or the non-transcending craters that thus separate those “segments” but that do not fully divide or fully break or fully isolate any two such neighboring “segments” from each other. Upon its production, and prior to attaching the solar cells onto the floating medium layer, each such flexible and rollable solar cell is freestanding and carrier-less and non-supported.

In some embodiments, the non-transcending gaps or the “blind gaps” or craters or slits or grooves, are introduced and are formed only at a first side or at a first surface of the semiconductor substrate or body or wafer, and are not formed at both of the opposite surfaces (or sides) thereof.

In some embodiments, the non-transcending gaps or the “blind gaps” or craters or slits or trenches or grooves, are introduced and are formed only at a first side or at a first surface of the semiconductor substrate or body or wafer, that is intended to face the sunlight or the light, or that is the active side of the PV device or PV cell, or that is intended to be the active side of the PV device or PV cell, or that is intended to be the electricity-generating side or surface that would generated electricity based on incoming sunlight or light or based on the PV effect; and they are not formed at the other (e.g., opposite, non-active) side or surface (e.g., the side that is not intended to be facing the sunlight or the light, or the side that is not intended to be producing electricity based on the PV effect).

In other embodiments, the non-transcending gaps or the “blind gaps” or craters or slits or trenches or grooves, are not introduced and are not formed at the side or surface of the semiconductor substrate or body or wafer, that is intended to face the sunlight or the light, or that is the active side of the PV device or PV cell, or that is intended to be the active side of the PV device or PV cell, or that is intended to be the electricity-generating side or surface that would generated electricity based on incoming sunlight or light or based on the PV effect; but rather, those non-transcending gaps or the “blind gaps” or craters or slits or grooves are formed at the other (e.g., opposite, non-active) side or surface, which is the side that is not intended to be facing the sunlight or the light, or the side that is not intended to be producing electricity based on the PV effect. Some implementations with this structure may advantageously provide the mechanical shock absorption and the mechanical forces dissipation capability, yet may also provide or maintain or achieve an increased level of PV-based electricity production since the gaps do not reduce the area of the light-exposed side or the light-facing side of the PV device.

In still other embodiments, the non-transcending gaps or the “blind gaps” or craters or slits or trenches or grooves, are introduced and are formed at both sides or at both surfaces of the semiconductor substrate or body or wafer; yet with an offset among the gaps of the first side and the gaps of the second side, in a zig-zag pattern of those gaps which zig-zag across the two sides of the semiconductor wafer or substrate or body; for example, a first gap located at the top surface on the left; then, a second gap located at the bottom surface to the right side of the first gap and not overlapping at all with the first gap; then, a third gap located at the top surface to the right side of the second gap and not overlapping at all with the second gap; then, a fourth gap located at the bottom surface to the right side of the third gap and not overlapping at all with the third gap; and so forth. In such structure, for example, any single point or any single location or any single region of the remaining semiconductor wafer or substrate or wafer, may have a gap or a crater or a “blind gap” only on one of its two sides, but not on both of its sides.

In yet other embodiments, the non-transcending gaps or the “blind gaps” or craters or slits or grooves, are introduced and are formed at both sides or at both surfaces of the semiconductor substrate or body or wafer; not necessarily with an offset among the gaps of the first side and the gaps of the second side, and not necessarily in a zig-zag pattern; but rather, by implementing any other suitable structure or pattern that still provides the mechanical shock resilience, and while also maintaining a sufficiently-thin layer of semiconductor substrate or body or wafer that is not removed and that is resilient to mechanical shocks and mechanical forces due to the craters or gaps that surround it.

Some embodiments may include and/or may utilize one or more units, devices, connectors, wires, electrodes, and/or methods which are described in United States patent application publication number US 2016/0308155 A1, which is hereby incorporated by reference in its entirety. For example, some embodiments may include and may utilize an electrode arrangement which is configured to define or create a plurality of electricity collection regions, such that within each of the collection regions, at least two sets of conducting wires are provided such that they are insulated from each other, and the at least two sets of conducting wires are connected either in parallel or in series between the collection regions to thus provide accumulating voltage of charge collection. Some embodiments may include an electric circuit for reading-out or collection or aggregation of the generated electricity, configured as an electrode arrangement, including conducting wires arranged in the form of nets covering zones of a pre-determined area. The electrodes arrangement may be configured or structured to be stretched (e.g., rolled out) along the surface of the PV cell, and may be formed by at least two sets of conducting wires, and may cover a plurality of collection zones or collection regions.

Within each of the electricity collection zones or electricity aggregation zones, the different conducting wires are insulated from each other, to provide a certain voltage between them. At a transition between zones, the negative charges collecting conductive wire of one zone, is electrically connected to the positive charges collecting conductive wire of the adjacent or the consecutive zone. Thus, within each of the collection zones, the different sets of conducting wires are insulated from each other, while being connected in series between the zones. This configuration of the electrode arrangement allows accumulation or aggregation of electric voltage generated by charge collection along the surface of the PV device. The configuration of the electrode arrangement provides a robust electric collection structure.

The internal connections between the sets of conducting wires allow energy collection even if the surface being covered is not continuous, e.g., if a perforation occurs in the structure of the net. This feature of the electrode arrangement allows for using this technique on any surface exposed to photon radiation, while also allowing discontinuity if needed and without limiting or disrupting the electric charge collection.

For demonstrative purposes, some portions of the discussion relate to utilization of the flexible polyimide film (or strips, or bands, or straps, or surfaces) as part of a stand-alone solar panel or as part of a vehicular component or a vehicle; however, some embodiments may similarly provide a solution that can be utilized with, or in, or in conjunction with, other objects or articles or structures; for example, a roof, a roof shingle, a wall, a panel, a side-panel, a horizontal panel, a vertical panel, a slanted panel, an aircraft part, an aircraft, a drone part, a drone, a spacecraft part, a spacecraft, a marine vessel part, a marine vessel, a boat, a ship, a yacht, a floating device, a swimming pool cover or a lake cover, a submarine vessel part, a submarine vessel, a construction equipment or vehicle or agricultural machinery (e.g., bulldozer, tractor, harvester, cotton collector, crane), a bus-stop roof or structure, a gazebo roof, a patio roof, an awning, a greenhouse, a parking spot cover or a parking lot cover, a playground cover, a stadium cover or roof, a shed or a toolshed, a road divider, a road sign, a billboard, a shipping container (e.g., enabling the integration of the solar panel in a roof or side-panel of a shipping container, to provide electric power to electric devices within the container and/or to cooling systems or fans that can cool or can reduce the temperature of top-layer containers on ships), and/or other suitable objects or structures.

In some embodiments, the photovoltaic device or PV cell or solar panel, may be installed or mounted on top of a vehicle or on a vehicle; or may be an integral or integrated part of a vehicle or of a vehicular component. The term “vehicle” as used herein may comprise, for example, a car, a sedan car, a sport utility vehicle (SUV), a truck, a bus, a van, a minivan, a train, a wagon of a train, a car of a train, a military vehicle (e.g., a tank, an armored fighting vehicle (AFV), a combat vehicle, or the like), a first responder or law enforcement vehicle (e.g., police car, ambulance, firetruck), a cargo vehicle, a trailer, a mini-trailer, a vehicle for transporting persons and/or animals and/or other cargo, an agricultural vehicle or mobile agricultural equipment (e.g., a tractor, a combine harvester, a cotton harvester, a harvester, a crop sprayer, a hay baler, or the like), a vehicle having a generally flat roof, a vehicle having a curved roof, an autonomous car or vehicle, a self-driving car or vehicle, a remote-controlled car or vehicle, a remotely-controlled car or vehicle, an Electric Vehicle (EV), an Electric Utility Vehicle (EUV), an Internal Combustion Engine (ICE) vehicle or a gasoline vehicle that utilizes the solar panel to recharge its battery and/or to provide power to devices within the vehicle, a hybrid vehicle, or the like.

Some embodiments provide a solar panel, comprising: a central photovoltaic region, comprising one or more photovoltaic cells that are configured to convert light to electricity; at least one corrugated non-planar region, that is attached to the central photovoltaic region, configured to overlap a complementing corrugated non-planar region of another solar panel, and to enable nested mechanical attachment of said solar panel to said other solar panel.

In some embodiments, the at least one corrugated non-planar region is non-photovoltaic.

In some embodiments, the at least one corrugated non-planar region is photovoltaic and converts light to electricity.

In some embodiments, the at least one corrugated non-planar region is detachably attached to said central photovoltaic region.

In some embodiments, the at least one corrugated non-planar region is non-detachably attached to said central photovoltaic region.

In some embodiments, the at least one corrugated non-planar region is non-detachably attached to said central photovoltaic region; wherein (i) the at least one corrugated non-planar region, and (ii) the non-detachably attached central photovoltaic region, are both an integrated, singular, thermoformed article.

In some embodiments, the at least one corrugated non-planar region is non-detachably attached to said central photovoltaic region; wherein (i) the at least one corrugated non-planar region, and (ii) the non-detachably attached central photovoltaic region, are both an integrated, singular, thermoset article.

In some embodiments, the at least one corrugated non-planar region is non-detachably attached to said central photovoltaic region; wherein (i) the at least one corrugated non-planar region, and (ii) the non-detachably attached central photovoltaic region, are both an integrated, singular, thermoformed article having a heat-and-pressure integral thermoformed connection between (i) the at least one corrugated non-planar region and (ii) the non-detachably attached central photovoltaic region.

In some embodiments, the at least one corrugated non-planar region is non-detachably attached to said central photovoltaic region; wherein (i) the at least one corrugated non-planar region, and (ii) the non-detachably attached central photovoltaic region, are both an integrated, singular, article having am integral mechanical-force based connection between (i) the at least one corrugated non-planar region and (ii) the non-detachably attached central photovoltaic region.

In some embodiments, the at least one corrugated non-planar region is non-detachably attached to said central photovoltaic region; wherein (i) the at least one corrugated non-planar region, and (ii) the non-detachably attached central photovoltaic region, are both an integrated, singular, article having am integral mechanical pressure-difference based connection between (i) the at least one corrugated non-planar region and (ii) the non-detachably attached central photovoltaic region.

In some embodiments, the at least one corrugated non-planar region comprises: at least one surface that is slanted relative to a plane of the central photovoltaic region.

In some embodiments, the at least one corrugated non-planar region comprises: at least two surfaces that are slanted relative to a plane of the central photovoltaic region.

In some embodiments, the at least one corrugated non-planar region comprises: (I) at least one surface that is slanted relative to a plane of the central photovoltaic region, and (II) at least one surface that is parallel to the plane of the central photovoltaic region.

In some embodiments, the at least one corrugated non-planar region comprises: a curved or concave or convex or non-planar protrusion.

In some embodiments, a width of the at least one corrugated non-planar region, is in a range of 1 to 10 percent of an entire width of the solar panel.

In some embodiments, a height of the at least one corrugated non-planar region, is in a range of 0.1 to 10 percent of an entire width of the solar panel.

In some embodiments, a thickness of the central photovoltaic region is in a range of 0.1 to 10 millimeters; wherein the at least one corrugated non-planar region, protrudes upwardly an additional height of 10 to 100 millimeters relative to a top surface of the central photovoltaic region.

In some embodiments, a first corrugated region of said solar panel, is tightly attached beneath another corrugated region of another solar panel.

In some embodiments, a first corrugated region of said solar panel, is tightly attached by an adhesive beneath another corrugated region of another solar panel; wherein the first corrugated region of said solar panel, and the other corrugated region of the other solar panel, sandwich between them said adhesive and form a water-tight or water-proof mechanical connection.

In some embodiments, a first corrugated region of said solar panel, is tightly attached by a sealant beneath another corrugated region of another solar panel; wherein the first corrugated region of said solar panel, and the other corrugated region of the other solar panel, sandwich between them said sealant and form a water-tight or water-proof mechanical connection.

In some embodiments, a first corrugated region of said solar panel, is tightly attached by a mechanical connector beneath another corrugated region of another solar panel; wherein the first corrugated region of said solar panel, and the other corrugated region of the other solar panel, and said mechanical connector, form together a water-tight or water-proof mechanical connection.

In some embodiments, a metal conductor runs within a cavity of the at least one corrugated region of said solar panel; wherein said metal conductor aggregates and transports electricity generated by the central photovoltaic region.

In some embodiments, the at least one corrugated region comprises at least: a first corrugated region, located along a first edge of the solar panel; a second corrugated region, located along a second edge of the solar panel that is opposite the first edge of the solar panel.

In some embodiments, the at least one corrugated region comprises at least: a first corrugated region, located along a first edge of the solar panel; a second corrugated region, located along a second edge of the solar panel that is non-opposite relative to the first edge of the solar panel.

In some embodiments, the at least one corrugated region comprises at least: three corrugated regions, located along three edges of the solar panel.

In some embodiments, the solar panel is generally rectangular and has four edges; wherein the at least one corrugated region comprises at least: four corrugated regions, located along the four edges of the solar panel.

In some embodiments, the central photovoltaic region is flexible and rollable and foldable and non-brittle.

In some embodiments, the central photovoltaic region comprises a plurality of mechanically-interconnected and electrically-interconnected photovoltaic cells that are flexible and non-brittle.

In some embodiments, the central photovoltaic region is flexible and rollable and foldable and non-brittle, and includes a semiconductor wafer having non-transcending craters that penetrate into 75 to 99 percent of a thickness of the semiconductor wafer, wherein a thin portion of the semiconductor wafer remains intact and non-penetrated, wherein said non-transcending craters dissipate and absorb mechanical forces applied to the central photovoltaic region. In some embodiments, the non-transcending craters in the semiconductor wafer contain a filler material that further dissipates and absorbs mechanical forces. In some embodiments, the non-transcending craters in the semiconductor wafer contain a filler material, which comprises at least an elastomer, that further dissipates and absorbs mechanical forces.

In some embodiments, at least a portion of the at least one corrugated region is flexible and non-brittle.

In some embodiments, the solar panel is mounted on top of a roof of a building or a structure.

In some embodiments, the solar panel is functionally mounted as a roof of a building or a structure.

For demonstrative purposes, some of the drawings show a solar panel having two edges or two “wings” that are corrugated and are generally parallel to each other; however, some embodiments may similarly include, for example, a singular solar panel having three or four or five or other number of corrugated regions, which may be generally parallel to each other and may be generally parallel to one edge or two edges of the solar panel; such that the solar panel includes at least one upwardly-protruding region (which may be photovoltaic) between at least two other corrugated regions. For example, a flexible or rigid-flex solar panel may be produced, and may be formed or deformed or three-dimensionally structured to have a three-dimensional structure as described, via mechanical forces, pressure difference, or other means.

In some embodiments, the at least one corrugated region comprises at least: (a) a first corrugated wing that is located at a first edge of the solar panel and protrudes upwardly relative to the central photovoltaic region; (b) a second corrugated wing that is located at a second, opposite, edge of the solar panel and protrudes upwardly relative to the central photovoltaic region; (c) at least one central corrugated region, that is located between the first corrugated wing and the second corrugated wing, and that protrudes upwardly relative to the central photovoltaic region; wherein the first corrugated wing is parallel to the second corrugated wing; wherein the first corrugated wing is parallel to the at least one central corrugated region.

Some embodiments provide an article having mounted thereon a plurality of solar panels, each of said solar panels being in accordance with the above-mentioned features or some of them; wherein the article is an article selected from the group consisting of: a building, a shack, a toolshed, a warehouse, a storage unit, a vehicle, an aircraft, a marine vessel, a spacecraft, a floating article that autonomously self-floats on water.

Some embodiments provide a method for producing the solar panel, the method comprising: (a) producing the central photovoltaic region, which comprises one or more photovoltaic cells that are configured to convert light to electricity; (b) producing the at least one corrugated non-planar region, that is attached to the central photovoltaic region, configured to overlap a complementing corrugated non-planar region of another solar panel, and to enable nested mechanical attachment of said solar panel to said other solar panel.

In some embodiments, step (a) and step (b) are performed simultaneously using a single thermoforming process or a single thermosetting process, in which the solar panel is three-dimensionally structured utilizing heat and pressure to obtain said at least one corrugated region.

In some embodiments, step (a) and step (b) are performed simultaneously using a single mechanical process at ambient temperature and without heating, in which the solar panel is three-dimensionally structured utilizing mechanical forces to obtain said at least one corrugated region.

In some embodiments, step (a) and step (b) are performed simultaneously using a single mechanical process at ambient temperature and without heating, in which the solar panel is three-dimensionally structured utilizing pressure difference to obtain said at least one corrugated region.

In some embodiments, step (b) is performed separately from step (a) and after completion of step (a).

The terms “plurality” and “a plurality”, as used herein, include, for example, “multiple” or “two or more”. For example, “a plurality of items” includes two or more items.

References to “one embodiment”, “an embodiment”, “demonstrative embodiment”, “various embodiments”, “some embodiments”, and/or similar terms, may indicate that the embodiment(s) so described may optionally include a particular feature, structure, or characteristic, but not every embodiment necessarily includes the particular feature, structure, or characteristic. Furthermore, repeated use of the phrase “in one embodiment” does not necessarily refer to the same embodiment, although it may. Similarly, repeated use of the phrase “in some embodiments” does not necessarily refer to the same set or group of embodiments, although it may.

As used herein, and unless otherwise specified, the utilization of ordinal adjectives such as “first”, “second”, “third”, “fourth”, and so forth, to describe an item or an object, merely indicates that different instances of such like items or objects are being referred to; and does not intend to imply as if the items or objects so described must be in a particular given sequence, either temporally, spatially, in ranking, or in any other ordering manner.

Functions, operations, components and/or features described herein with reference to one or more embodiments, may be combined with, or may be utilized in combination with, one or more other functions, operations, components and/or features described herein with reference to one or more other embodiments. Some embodiments may thus comprise any possible or suitable combinations, re-arrangements, assembly, re-assembly, or other utilization of some or all of the modules or functions or components that are described herein, even if they are discussed in different locations or different chapters of the above discussion, or even if they are shown across different drawings or multiple drawings.

While certain features of some demonstrative embodiments have been illustrated and described herein, various modifications, substitutions, changes, and equivalents may occur to those skilled in the art. Accordingly, the claims are intended to cover all such modifications, substitutions, changes, and equivalents.

What is claimed is:

1. A solar panel, comprising:
a central photovoltaic region, comprising one or more photovoltaic cells that are configured to convert light to electricity;
at least one corrugated non-planar region, that is attached to the central photovoltaic region, configured to overlap a complementing corrugated non-planar region of another solar panel, and to enable nested mechanical attachment of said solar panel to said other solar panel.

2. The solar panel of claim 1,
wherein the at least one corrugated non-planar region is non-photovoltaic.

3. The solar panel of claim 1,
wherein the at least one corrugated non-planar region is photovoltaic and converts light to electricity.

4. The solar panel of claim 1,
wherein the at least one corrugated non-planar region is detachably attached to said central photovoltaic region.

5. The solar panel of claim 1,
wherein the at least one corrugated non-planar region is non-detachably attached to said central photovoltaic region.

6. The solar panel of claim 5,
wherein the at least one corrugated non-planar region is non-detachably attached to said central photovoltaic region;
wherein (i) the at least one corrugated non-planar region, and (ii) the non-detachably attached central photovoltaic region, are both an integrated, singular, thermoformed article.

7. The solar panel of claim 5,
wherein the at least one corrugated non-planar region is non-detachably attached to said central photovoltaic region;
wherein (i) the at least one corrugated non-planar region, and (ii) the non-detachably attached central photovoltaic region, are both an integrated, singular, thermoset article.

8. The solar panel of claim 5,
wherein the at least one corrugated non-planar region is non-detachably attached to said central photovoltaic region;
wherein (i) the at least one corrugated non-planar region, and (ii) the non-detachably attached central photovoltaic region, are both an integrated, singular, thermoformed article having a heat-and-pressure integral thermoformed connection between (i) the at least one corrugated non-planar region and (ii) the non-detachably attached central photovoltaic region.

9. The solar panel of claim 5,
wherein the at least one corrugated non-planar region is non-detachably attached to said central photovoltaic region;
wherein (i) the at least one corrugated non-planar region, and (ii) the non-detachably attached central photovoltaic region, are both an integrated, singular, article having am integral mechanical-force based connection between (i) the at least one corrugated non-planar region and (ii) the non-detachably attached central photovoltaic region.

10. The solar panel of claim 5,
wherein the at least one corrugated non-planar region is non-detachably attached to said central photovoltaic region;
wherein (i) the at least one corrugated non-planar region, and (ii) the non-detachably attached central photovoltaic region, are both an integrated, singular, article having am integral mechanical pressure-difference based connection between (i) the at least one corrugated non-planar region and (ii) the non-detachably attached central photovoltaic region.

11. The solar panel of claim 1,
wherein the at least one corrugated non-planar region comprises:
at least one surface that is slanted relative to a plane of the central photovoltaic region.

12. The solar panel of claim 1,
wherein the at least one corrugated non-planar region comprises:
at least two surfaces that are slanted relative to a plane of the central photovoltaic region.

13. The solar panel of claim 1,
wherein the at least one corrugated non-planar region comprises:
at least one surface that is slanted relative to a plane of the central photovoltaic region, and
at least one surface that is parallel to the plane of the central photovoltaic region.

14. The solar panel of claim 1,
wherein the at least one corrugated non-planar region comprises:
a curved or concave or convex or non-planar protrusion.

15. The solar panel of claim 1,
wherein a width of the at least one corrugated non-planar region
is in a range of 1 to 10 percent of an entire width of the solar panel.

16. The solar panel of claim 1,
wherein a height of the at least one corrugated non-planar region
is in a range of 0.1 to 10 percent of an entire width of the solar panel.

17. The solar panel of claim 1,
wherein a thickness of the central photovoltaic region is in a range of 0.1 to 10 millimeters;
wherein the at least one corrugated non-planar region
protrudes upwardly an additional height of 10 to 100 millimeters relative to a top surface of the central photovoltaic region.

18. The solar panel of claim 1,
wherein a first corrugated region of said solar panel
is tightly attached beneath another corrugated region of another solar panel.

19. The solar panel of claim 1,
wherein a first corrugated region of said solar panel
is tightly attached by an adhesive beneath another corrugated region of another solar panel;
wherein the first corrugated region of said solar panel, and the other corrugated region of the other solar panel, sandwich between them said adhesive and form a water-tight or water-proof mechanical connection.

20. The solar panel of claim 1,
wherein a first corrugated region of said solar panel
is tightly attached by a sealant beneath another corrugated region of another solar panel;
wherein the first corrugated region of said solar panel, and the other corrugated region of the other solar panel, sandwich between them said sealant and form a water-tight or water-proof mechanical connection.

21. The solar panel of claim 1,
wherein a first corrugated region of said solar panel
is tightly attached by a mechanical connector beneath another corrugated region of another solar panel;
wherein the first corrugated region of said solar panel, and the other corrugated region of the other solar panel, and said mechanical connector, form together a water-tight or water-proof mechanical connection.

22. The solar panel of claim 1, further comprising:
a metal conductor that runs within a cavity of the at least one corrugated region of said solar panel, wherein said metal conductor aggregates and transports electricity generated by the central photovoltaic region.

23. The solar panel of claim 1,
wherein the at least one corrugated region comprises at least:
a first corrugated region, located along a first edge of the solar panel;
a second corrugated region, located along a second edge of the solar panel that is opposite the first edge of the solar panel.

24. The solar panel of claim 1,
wherein the at least one corrugated region comprises at least:
a first corrugated region, located along a first edge of the solar panel;
a second corrugated region, located along a second edge of the solar panel that is non-opposite relative to the first edge of the solar panel.

25. The solar panel of claim 1,
wherein the at least one corrugated region comprises at least:
three corrugated regions, located along three edges of the solar panel.

26. The solar panel of claim 1,
wherein the solar panel is generally rectangular and has four edges;
wherein the at least one corrugated region comprises at least:
four corrugated regions, located along the four edges of the solar panel.

27. The solar panel of claim 1,
wherein the central photovoltaic region is flexible and rollable and foldable and non-brittle.

28. The solar panel of claim 1,
wherein the central photovoltaic region comprises a plurality of mechanically-interconnected and electrically-interconnected photovoltaic cells that are flexible and non-brittle.

29. The solar panel of claim 1,
wherein the central photovoltaic region is flexible and rollable and foldable and non-brittle, and includes a semiconductor wafer having non-transcending craters that penetrate into 75 to 99 percent of a thickness of the semiconductor wafer, wherein a thin portion of the semiconductor wafer remains intact and non-penetrated, wherein said non-transcending craters dissipate and absorb mechanical forces applied to the central photovoltaic region.

30. The solar panel of claim 29,
wherein the non-transcending craters in the semiconductor wafer contain a filler material that further dissipates and absorbs mechanical forces.

31. The solar panel of claim 29,
wherein the non-transcending craters in the semiconductor wafer contain a filler material, which comprises at least an elastomer, that further dissipates and absorbs mechanical forces.

32. The solar panel of claim 31,
wherein at least a portion of the at least one corrugated region
is flexible and non-brittle.

33. The solar panel of claim 1,
wherein the at least one corrugated region comprises at least:
a first corrugated wing that is located at a first edge of the solar panel and protrudes upwardly relative to the central photovoltaic region;
a second corrugated wing that is located at a second, opposite, edge of the solar panel and protrudes upwardly relative to the central photovoltaic region;
at least one central corrugated region, that is located between the first corrugated wing and the second corrugated wing, and that protrudes upwardly relative to the central photovoltaic region;
wherein the first corrugated wing is parallel to the second corrugated wing;
wherein the first corrugated wing is parallel to the at least one central corrugated region.

34. The solar panel of claim 1,
wherein the solar panel is mounted on top of a roof of a building or a structure.

35. An article having mounted thereon a plurality of solar panels,
each of said solar panels being in accordance with claim 1;
wherein the article is an article selected from the group consisting of:
a building, a shack, a toolshed, a warehouse, a storage unit,
a vehicle, an aircraft, a marine vessel, a spacecraft,
a floating article that floats on water.

36. A method for producing the solar panel of claim 1,
the method comprising:
(a) producing the central photovoltaic region, which comprises one or more photovoltaic cells that are configured to convert light to electricity;
(b) producing the at least one corrugated non-planar region, that is attached to the central photovoltaic region, configured to overlap a complementing corrugated non-planar region of another solar panel, and to enable nested mechanical attachment of said solar panel to said other solar panel.

37. The method of claim 36,
wherein step (a) and step (b) are performed simultaneously using a single thermoforming process or a single thermosetting process, in which the solar panel is three-dimensionally structured utilizing heat and pressure to obtain said at least one corrugated region.

38. The method of claim 36,
wherein step (a) and step (b) are performed simultaneously using a single mechanical process at ambient temperature and without heating, in which the solar panel is three-dimensionally structured utilizing mechanical forces to obtain said at least one corrugated region.

39. The method of claim 36,
wherein step (a) and step (b) are performed simultaneously using a single mechanical process at ambient temperature and without heating, in which the solar panel is three-dimensionally structured utilizing pressure difference to obtain said at least one corrugated region.

40. The method of claim 36,
wherein step (b) is performed separately from step (a) and after completion of step (a).
